(19) United States
(12) Patent Application Publication
(10) Pub. No.: US 2024/0345894 A1
(43) Pub. Date: Oct. 17, 2024

(54) CROSS-PLATFORM COMPUTATIONAL GRAPH IMPORTING, CUSTOMIZATION AND EXECUTION

(71) Applicant: Unity Technologies SF, San Francisco, CA (US)

(72) Inventors: Alexandre Ribard, Montreal (CA); Giles Coope, Berlin (DE); Tracy Sharpe, Seattle, WA (US); Sylvio Herve Drouin, San Francisco, CA (US); John Salvatore Riccitielllo, San Francisco, CA (US)

(21) Appl. No.: 18/636,172

(22) Filed: Apr. 15, 2024

Related U.S. Application Data
(60) Provisional application No. 63/459,200, filed on Apr. 13, 2023.

(51) Int. Cl. G06F 9/50; G06F 9/48

(52) U.S. Cl. CPC G06F 9/5061; G06F 9/4881

(57) ABSTRACT

System and methods for importing, converting, optimizing and/or executing a computational graph or AST at an endpoint target. The system includes accessing an input computational graph corresponding to a trained machine-learning (ML) model; converting the input computational graph into an internal computational graph; based on determined characteristics of the internal computational graph, optimizing the internal computational graph to generate an optimized computational graph by applying one or more of at least a graph element reordering operation, a graph element fusing operation, or a graph element creation operation; converting the optimized computational graph to executable instructions enabled to be executed on an endpoint associated with a backend and a platform; generating associated scheduling instructions; and executing the executable instructions on the endpoint based on the scheduling instructions. The executable instructions can forgo references to the input, internal or optimized computational graphs, and/or be reused by other systems, engines or applications.

### CROSS-REFERENCE TO RELATED APPLICATIONS

This application claims the benefit of U.S. Provisional Application 63/459,200, entitled “SYSTEMS AND METHODS FOR CROSS-PLATFORM COMPUTATION GRAPH IMPORTING, CUSTOMIZATION AND EXECUTION,” filed on Apr. 13, 2023, which is hereby incorporated by reference in its entirety.

### TECHNICAL FIELD

The disclosed subject matter relates generally to the technical field of machine learning and, in one specific example, to a system for importing, customizing and/or executing a computational graph (e.g., corresponding to a machine-learned model).

### BACKGROUND

Given the expanding ecosystem of machine learning (ML) model training and development packages and environments, users and companies are increasingly interested in interoperability and/or the ability to run imported, created or customized models on one or more end platforms of their choice.

### BRIEF DESCRIPTION OF THE SEVERAL VIEWS OF THE DRAWINGS

Some embodiments are illustrated by way of example and not limitation in the figures of the accompanying drawings.

FIG. 1 is a network diagram illustrating a system within which various example embodiments may be deployed.

FIG. 2 is a block diagram illustrating a model execution system which imports, optimizes, customizes and/or executes a model, according to some examples.

FIG. 3 is an illustration of a partial view of a model execution system, according to some examples.

FIG. 4 is an illustration of a partial view of a model execution system, according to some examples.

FIG. 5 is an illustration of a partial view of a model execution system, according to some examples.

FIG. 6 is an illustration of a partial view of a model execution system, according to some examples.

FIG. 7 is an illustration of a partial view of a model execution system, according to some examples.

FIG. 8 is an illustration of a partial view of a model execution system, according to some examples.

FIG. 9 is an illustration of a partial view of a model execution system, according to some examples.

FIG. 10 is an illustration of a partial view of a model execution system, according to some examples.

FIG. 11 is an illustration of a partial view of a model execution system, according to some examples.

FIG. 12 is an illustration of a partial view of a model execution system, according to some examples.

FIG. 13 is an illustration of a partial view of a model execution system, according to some examples.

FIG. 14 is an illustration of a partial view of a model execution system, according to some examples.

FIG. 15 is a flowchart illustrating a method, as implemented by a model execution system, according to some examples.

FIG. 16 is an illustration of a partial view of a model execution system, according to some examples.

FIG. 17 is a block diagram illustrating components of a machine, according to some examples, able to read instructions from a machine-readable medium (e.g., a machine-readable storage medium) and perform any one or more of the methodologies discussed herein.

FIG. 18 is a block diagram illustrating an example of a software architecture that may be installed on a machine, according to some examples.

FIG. 19 is a block diagram illustrating a machine learning program, according to some examples.

### DETAILED DESCRIPTION

The recent proliferation of development and training environments for machine learning (ML) models has led to an increased focus on interoperability, given the desirability of importing and using ML models regardless of their original development and/or training platform (e.g., PyTorch, TensorFlow, Keras, etc.). For example, customers are interested in deploying imported models as part of applications or engines on a variety of target devices (e.g., mobile phones, desktop computers, etc.) associated with various backends (e.g., GPU/CPU/TPU/NPU, etc.) and/or platforms (Microsoft Windows, IOS, Android, Linux, macOS, PlayStation 4 (PS4), and so forth). Customers are further interested in customizing or optimizing imported models, as well as creating, deploying and/or exporting their own models.

Current solutions for ML model importing and/or execution enable the importing of previously created ML models stored in a common format, such as Open Neural Network Exchange (e.g., ONNX). However, such models and/or associated computational graphs have been typically optimized in the context of a development and/or training environment. Therefore, they likely need additional optimizations and/or modifications in the context of a new development environment and/or new deployment environment. For example, the imported ML model may not be tailored for efficient execution on a specific endpoint of interest to the customer, the endpoint being associated with a specific backend and/or platform. Furthermore, current ML model importing and/or execution solutions do not offer straightforward customization options for an imported ML model. For example, in the case of an imported neural network (NN) model, current solutions do not offer a straightforward way for a customer to modify, optimize, or replace the set of used operators, the implementations of operators, or the structure of the model itself.

Therefore, there is a need for a model execution system to address the problems of importing and/or executing an imported model across different backends, platforms, and/or environments. To improve execution performance on platforms, backends or target devices with limited resources and/or choice specifications and/or requirements, the model execution system should optimize the model structure and/or its execution. The model execution system should also enable a high degree of customization and/or extensibility associated with the imported model, and/or with the process of optimizing and/or executing the model.

Example embodiments in the disclosure herein describe a model execution system that addresses the above technical problems, as well as others. The model execution system is capable of importing, customizing and/or executing models (e.g., trained ML models such as trained NN models, etc.) on one or more endpoints associated with a variety of platforms and/or backends. Example platforms include Microsoft Windows, IOS, Android, PS4, WebGL, and so forth. Example backends include GPU, CPU, TPU, NPU, and so forth. In some examples, the model execution system imports a model stored using an Open Neural Network Exchange (ONNX) format, or other formats corresponding to a computational graph representation. The model execution system converts the imported model to an internal model and/or associated representation such as an internal computational graph or abstract syntax tree (AST) structure. The model execution system addresses the problem of computational graph optimization via a transpiler module that analyzes the internal computational graph or AST and/or performs optimization passes to improve execution speed and flexibility. The model execution system can automatically convert code corresponding to the executable internal computational graph (or AST) to code that uses a native API of a target platform. The model execution system can generate one or more execution artifacts (e.g., code) corresponding to an executable internal computational graph (or AST) such that the execution artifacts forgo any dependencies on any part of internal representations or capabilities of the model execution system that produced them. Thus, an imported, optimized and/or customized model can be run outside of the model execution system. The model execution system has a high degree of customization and/or extensibility: it supports user-provided modifications or extensions to a default set of system-supported operators used by the internal computational graph, the integration and/or optimization of user-specified models, the user-driven modification of imported model structure, and/or the reuse of system component for new goals not associated with model execution.

In some examples, the model execution system analyzes the internal computation graph or AST to make inferences with respect to the structure of the internal computational graph or AST. In some examples, the internal computational graph or AST includes a set of layers, each layer corresponding to an operator (e.g., a convolution operator, an addition operator, and so forth). Layers can be implemented using a generic and/or extensible layer class customized to represent different layer types or operator types. Layer inputs and/or outputs can be represented as tensors. In some examples, the use of an internal AST structure and/or the use of a generic layer representation enables efficient analysis and/or information gathering with respect to the internal computational graph or AST. Analysis examples include determining whether the graph is topologically sorted, or determining layer input or output information by performing partial tensor shape and/or tensor data-related inference. Inferred information can be propagated or passed down the graph (e.g., in the form of partial tensor shape propagation, tensor data format propagation, and so forth). A transpiler module can use the inferred and/or propagated information to determine one or more modification or optimization passes over the internal computational graph or AST, generating an optimized internal computational graph or AST. Modification or optimization passes include layer fusing, constant fusing, subgraph fusing, re-ordering the internal computational graph to be more memory efficient, and so forth. The model execution system can analyze the internal computation graph or AST to determine further memory allocation requirements or allocation schemes such as determining whether memory can be pre-allocated to reduce runtime allocation needs, deciding a high-performance scheduling scheme involving a determination of layers or models that should run on a CPU or GPU, and so forth.

In some examples, operators corresponding to the layers in the internal computational graph are associated with one or more backend-specific implementations (e.g., kernels). In some examples, the model execution system can optimize the execution of an internal computational graph (or AST) by generating a single file that executes the entire graph in one execution or dispatch, rather than performing multiple dispatches. The generation of the single file is based on fusing kernels corresponding to the different operators corresponding to the internal computational graph layers.

In some examples, backend implementation code is compiled to target a desired end platform, such as PS4, Microsoft Windows, WebGL, and so forth. In some examples, the model execution system can automatically convert an internal computational graph (or AST) to a file (e.g., an output “.shader” file) with no dependencies on internal representation(s), functions or capabilities of the model execution system that produced, optimized and/or customized it. Thus, the internal computational graph or AST can be run as part of a new system, engine, or platform.

In some examples, the model execution system supports the integration of user-supplied customization operations at one or more points in a model import and/or execution pipeline. The model execution system supports and integrates user-provided modifications or extensions to a default set of system-supported operators. The model execution system also enables instantiating support for operators in an input model computational graph that are missing from the default set of operators supported by the model execution system. Given an internal computation graph or AST structure, the model execution system automatically modifies and/or validates, based on user-provided input, the internal computation graph or AST structure. Such modifications include adding custom modification or optimization passes, creating custom layers, modifying, merging or simplifying existing or custom layers, and so forth. The model execution system provides a helper/operator scheduling interface and/or module that enables users to specify layer-specific execution graphs, specify which layers or parts of the model should run on a CPU or a GPU, specify whether a model graph should be fully compiled to a single output file, and so forth.

In some examples, one or more of the components of the model execution system can be repurposed for additional use cases. For example, an interface and/or module for operator execution scheduling can support specified tensor manipulations, or perform mathematical operations (e.g., multiplying matrices, inverting a matrix, etc.) in the context of a user-specified backend. By enabling the model execution pipeline, specific modules, internal representation(s) and their components to incorporate user input, the model execution system can achieve improved extensibility and flexibility, improved operator support and/or increased robustness with respect to model imports, as well as improved runtime performance. For example, user-specified changes to the model can leverage domain knowledge to simplify or modify the model in a manner that reduces runtime requirements in the context of a particular device or target platform.

### FIGURE SUMMARY

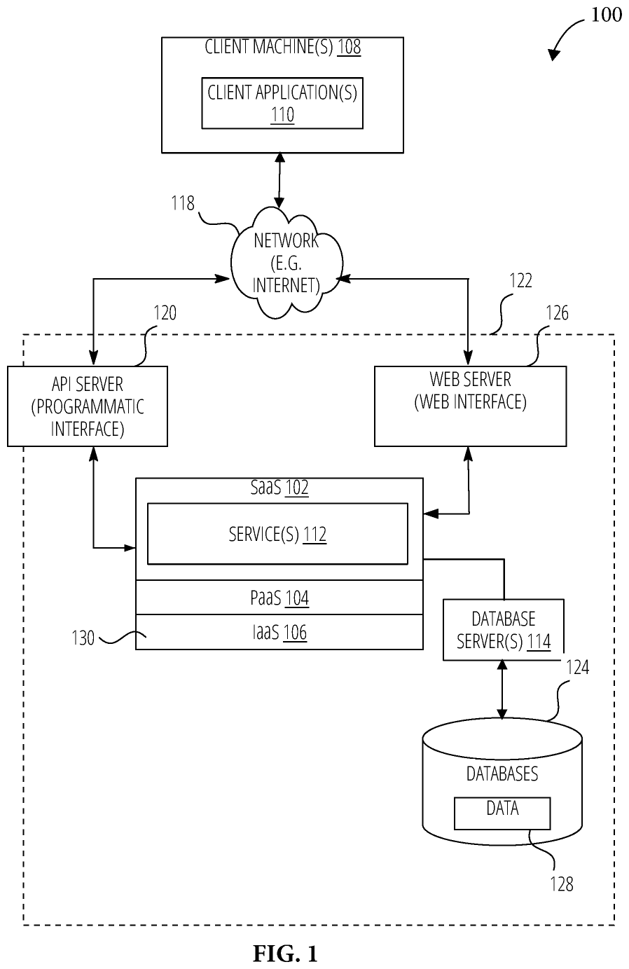

FIG. 1 is a network diagram depicting a system within which various example embodiments described herein may be deployed.

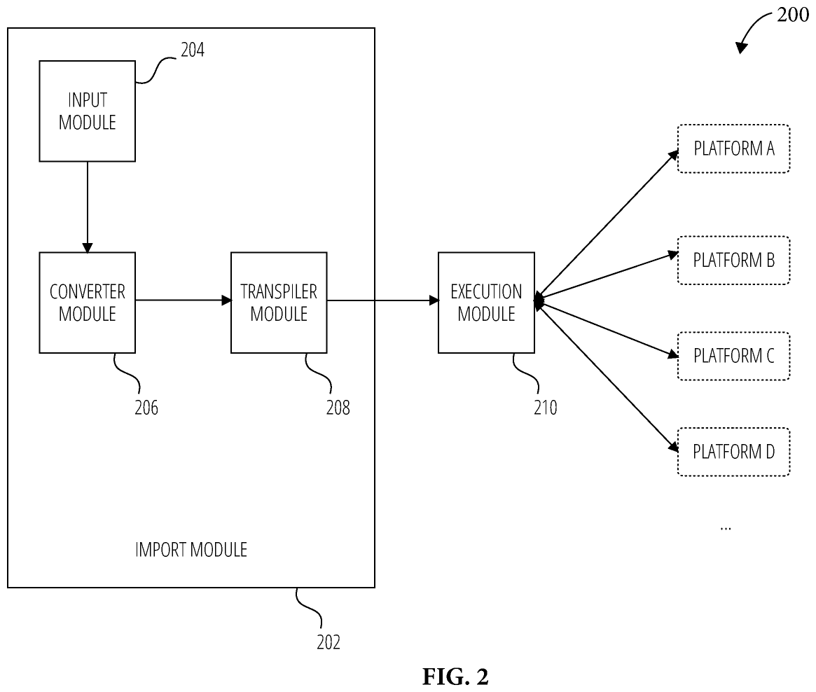

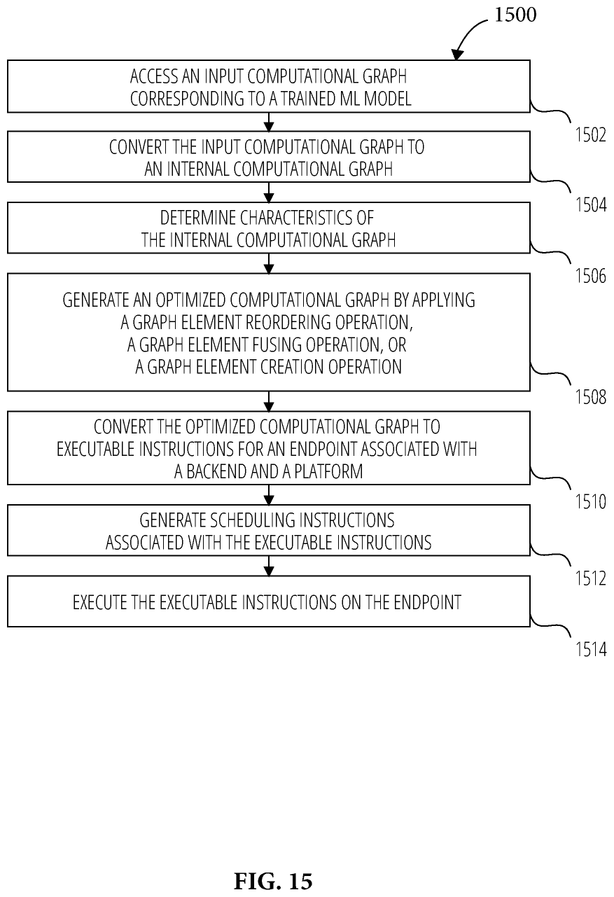

FIG. 2 and FIG. 15 give an overview of a model execution system and an example method implemented by the model execution system.

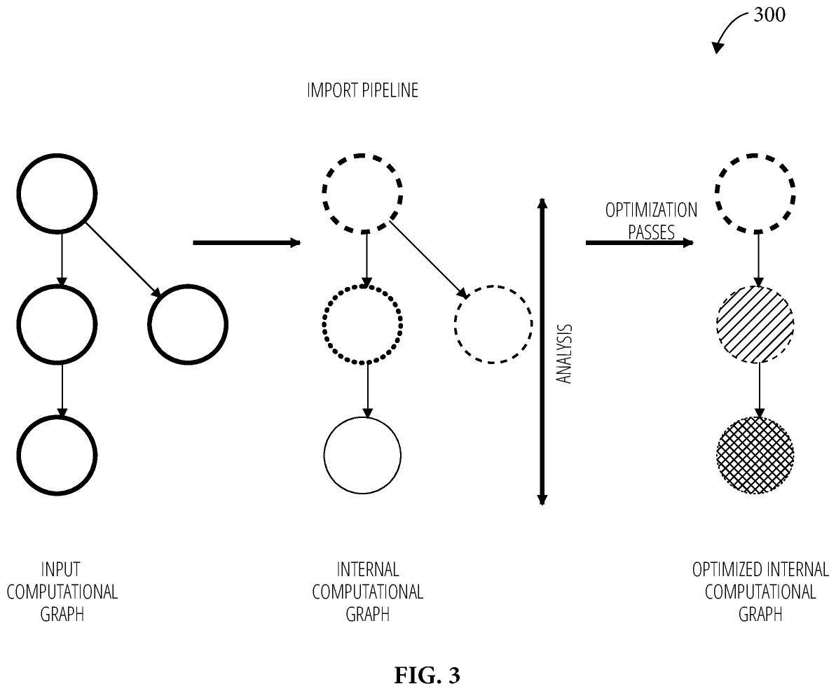

FIG. 3-FIG. 7 collectively illustrate partial views of an example model import pipeline that supports importing an input computational graph, converting it to an internal representation suitable for optimization, analyzing its structure, and/or applying modification and/or optimization passes.

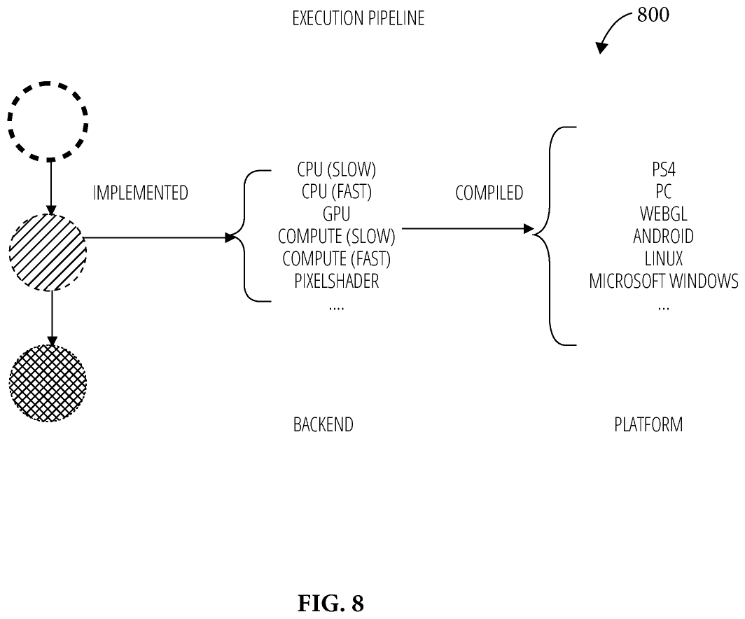

FIG. 8-FIG. 14 collectively illustrate partial views of an example model execution pipeline, showing examples of how a computational graph is prepared for execution, interfaced with different backends, how execution code is generated and/or potentially exported for use outside the model execution system.

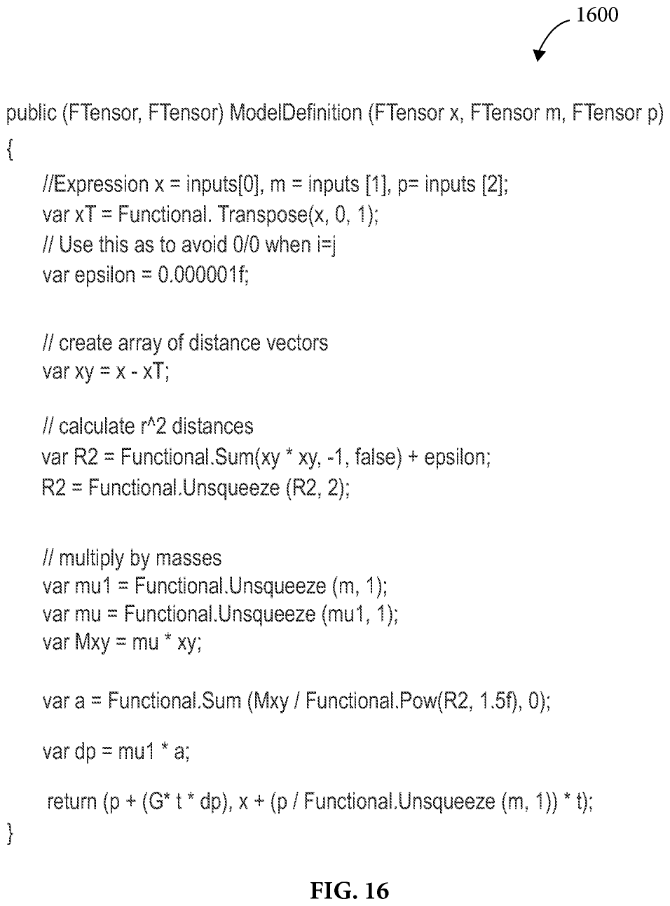

FIG. 16 provides an example of user code describing a model, the user code to be consumed by the model execution system.

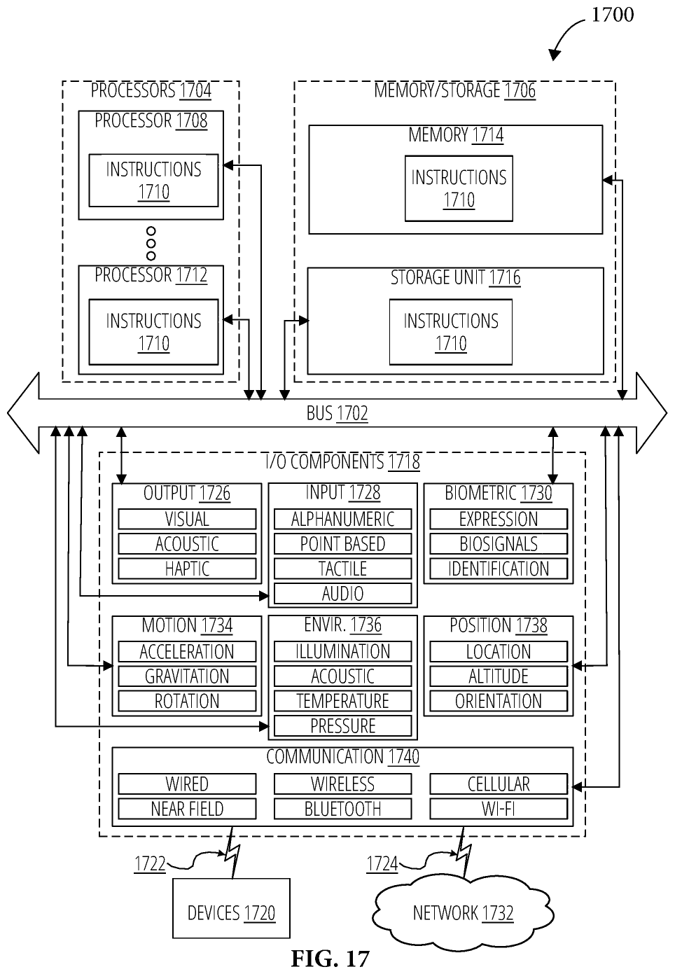

FIG. 17-FIG. 19 illustrate the components of a machine capable of executing the instructions of model execution system, an associated software architecture, as well as a structure of a ML program corresponding, for example, to a model imported, customized and/or executed by the model execution system.

FIG. 1 is a network diagram depicting a system 100 within which various example embodiments described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon a infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110, may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

FIG. 2 is a block diagram illustrating a model execution system 200 for importing, optimizing, customizing and/or executing a model in a cross-platform setting, according to some examples. The model execution system 200 comprises one or more Application Programming Interfaces (APIs) and/or one or more libraries for model importing, conversion, optimization, customization and/or execution in a cross-platform setting.

The model execution system 200 includes modules and components such as an import module 202, and/or an execution module 210. The import module 202 corresponds to an import pipeline (see, e.g., FIG. 3), while the execution module 210 corresponds to an execution pipeline (see, e.g., FIG. 8). The model execution system 200 operates in conjunction with one or more deployment platforms, such as platforms A, B, C or D.

The import module 202 includes an input module 204, a converter module 206, and/or a transpiler module 208. The number, order, configuration or data flow(s) of the modules and components of the model execution system 200 vary across example implementations for model execution system 200. For example, transpiler module 208 can be part of converter module 206, model execution system 200 can include multiple same-type modules (e.g., multiple input modules 204), one or more input modules 204 can provide input to transpiler module 208 or to the execution module 210, and so forth. The disclosure herein uses throughout the illustrative example of a trained machine ML model (e.g., a trained NN model). However, systems and methods disclosed herein can accommodate additional model types, ensembles of models, partial or complete computation graphs, and so forth.

The input module 204 accesses, receives, reads or loads an input computational graph. The input computational graph can be stored across one or more files using one or more storage formats (e.g., the Open Neural Network (ONNX) format, a TensorFlow output format, Torch or PyTorch output format, Keras output format, and/or any other formats used by choice model training and/or development platforms) corresponding to model training and development platforms). In some examples, the input computational graph corresponds to an input abstract syntax tree (AST) structure.

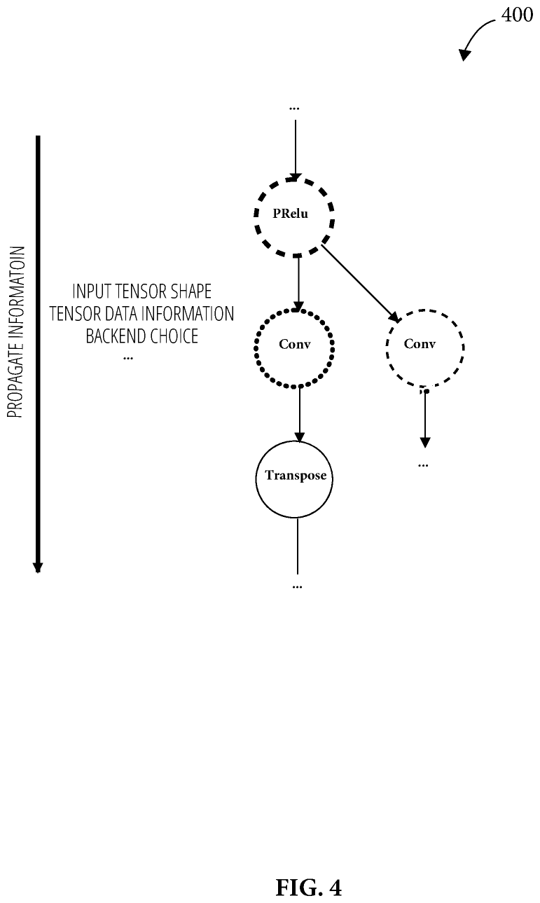

The converter module 206 converts the input computational graph into an internal representation such as an internal computational graph, or internal AST structure, for further processing and eventual execution (see, e.g., at least FIG. 3 and FIG. 4 for details). The internal computational graph (or internal AST) can correspond to a higher level of abstraction than the input computational graph or AST (see, e.g., FIG. 3 for details).

The transpiler module 208 accesses an internal computational graph (or internal AST). The transpiler module 208 analyzes it and/or, based on the analysis, produces modified or optimized versions of the internal computational graph corresponding to a modified or optimized internal model representation. The transpiler module 208 can be part of an import pipeline, as implemented by the import module 202 (see, e.g., at least FIG. 3 and FIG. 4 for details).

The execution module 210 is responsible for executing layers of an internal computational graph (or AST). The execution module 210 can correspond to an execution pipeline. The execution module 210 comprises a backend interface with one or more levels of virtual abstractions, which can be used to specify a backend for running the internal computational graph (or AST). Backend examples include CPU (slow), CPU (fast), GPU, Compute (e.g., ComputeShader), PixelShader, Burst, and so forth (see, e.g., FIG. 8).

Layers of the internal computational graph (or AST) correspond to operators that are implemented on each backend of a set of backends. The execution module 210 can produce shader code (e.g., “.shader” files) and scheduling instructions. The execution module 210 uses a compiler (e.g., a Burst compiler, a UnityShaderCompiler etc.) to compile backend-specific implementation code in order to generate compiled code to be executed on a target platform and/or engine (e.g., PS4, Windows, IOS, Android, WebGL). In some examples, the shader code and the scheduling instructions can be automatically converted or automatically ported to code corresponding to a native API (e.g., native graphics API) of the target platform.

Thus, model execution system 200 can convert an imported computational graph to an internal computational graph (or AST), compile the internal computational graph (or AST) to shader code and/or scheduling instructions and/or cross-compile or convert the shader code and/or scheduling instructions in the context of a target platform's native API. The execution module 210 can generate an execution artifact (e.g., the cross-compiled code) that is agnostic to any internal representation, function, or capability of the model execution system 200, and/or can be executed or repurposed outside of the model execution system 200. Thus, the execution module 210 an execution module 210 can “bake down” or convert an internal computational graph (corresponding to an imported and converted model) to an output file that enables the imported model to be run as part of a new system, engine or platform.

FIG. 3 is an illustration of a partial view 300 of a model execution system 200, according to some examples, corresponding to an import pipeline as implemented by an input module 204. The import pipeline can receive or load a model represented by an input computational graph (e.g., a computational graph in ONXX format, a Torch/PyTorch/TensorFlow computational graph, and so forth). The import pipeline converts the input computational graph to an internal computational graph using, for example, a converter module 206.

The input computational graph includes nodes or layers corresponding to a first input set of operators. In some examples, the operators correspond to mathematical operations operating on input data and producing output data (e.g., in the case of NN models, matrix multiplication operations/convolution operations, activation function operations, input reshaping/reformatting operations such as resizing or transposing operations, dimension reduction operations, and so forth). Additional mathematical operations can include other general mathematical operations (e.g., addition, division, min, max, and so forth). Layer inputs and/or layer outputs can be tensors, with the input computational graph using a first tensor format or tensor layout. The internal computational graph includes layers corresponding to operators in a second, internal set of operators, and/or a second, internal tensor format or tensor layout for layer input(s) and outputs in the form of tensors. The internal set of operators can be the same as, or different from, the input set of operators. The second, internal tensor format or layout can be the same as, or different from, the first tensor format or layout. The first and/or second tensor format can be the channels-first format (NCHW), the channels-last format (NHWC), and so forth. In some examples, the model execution system 200 allows for the use of tensors with a fully specified shape, or with a partially specified shape (see, e.g., FIG. 4 for further details).

In some examples, the internal computational graph is an internal AST, where each node in the tree corresponds to a layer of the internal computational graph, the layer associated with an operator (see, e.g., FIG. 4). The use of a tree structure further enables and/or simplifies the analysis of the internal computational graph, allowing for significant manipulation, modification and/or optimization of the internal representation of the imported model.

The model execution system 200 implements each layer or node in the internal computational graph (or internal AST) via a generic Layer class. For example, each layer or node is a Layer object with distinct properties or attributes. The Layer class has subclasses corresponding to various layers and/or operators: Conv (e.g., a layer corresponding to a convolution operation), MaxPool (e.g., a layer associated with a max pooling operation), Reshape (e.g., a layer associated with an operation for updating the shape of a tensor) and so forth. The model execution system 200 implements such subclasses and/or more specific layers by using all or some of the parameters associated with the Layer class. If not needed, some parameters can be omitted. Otherwise, parameters can be customized by being set to specific values. An example parameter set for the Layer class can be seen below:
Layer: string[ ] inputs, string outputs, float alpha, float beta, int[ ] values, DataSet (float[ ], TensorShape)

In an example, given the above Layer parametrization, a Conv layer corresponding to a convolution operator that takes as input tensors W and B can be created using a “New Layer (Conv, Pack (W, B) in dataset))” call, where W and B are to be transposed (e.g., Transpose (W), Transpose (B)) before being packed into a Layer.DataSet.

In some examples, layers of an internal computational graph (or internal AST) can correspond to both NN-related operators (matrix multiplication, activation functions, etc.) as well as general mathematical operations (see, e.g., https://docs.unity3d.com/Packages/com.unity.sentis@1.2/api/Unity.Sentis.Layers.html for a list of supported layers). Examples of layers associated with supported operators are illustrated throughout the disclosure herein.

In some examples, the converter module 206 converts the input computational graph (or input AST) into an internal computational graph representation (or internal AST) by converting, in place, each input layer (or operator) to an internal layer e.g., “for each layer in onnx: ConvertLayerToBarracuda(layer)”, where “onnx” denotes the input computational graph (here, a ONNX computational graph), and Barracuda denotes the name of the internal computational graph library (e.g., Unity Barracuda, or, in other examples, Unity Sentis). In some examples, the input computational graph can be an ExecuTorch computational graph, and so forth. The converter module 206 maps each layer in the input computational graph to a set of layers and/or operators supported by the model execution system 200. As an illustrative example, the sample conversion code below creates a Split layer in an internal computational graph based on an input computational graph.

```
            Add(“Split”, (net, node) =>
{
    var axis = node.AxisOptional(0);
    if (node.HasAttribute(“num_outputs”))
    {
      // Split-18 with “num_outputs” attribute
          net.AddLayer(new Layers.Split(node.Name, node.Input0, node.Outputs, axis,
            node.GetRequiredInt(“num_outputs”)));
    }
    else if (node.HasAttribute(“split”))
    {
      // Split-1, Split-2, Split-11 with “split” attribute
      var split = node.GetRequiredIntArray(“split”);
      var splitConstant = new Layers.Constant(net.GetUniqueIndex(node.Name +
      “_split”), split);
      net.AddConstant(splitConstant);
      net.AddLayer(new Layers.Split(node.Name, node.Input0, splitConstant.index,
      node.Outputs, axis));
        }
    else if (node.InputCount == 2)
    {
      // Split-1, Split-13, Split-18 with “split” input
      net.AddLayer(new Layers.Split(node.Name, node.Input0, node.Input1,
      node.Outputs, axis));
  }
    else
    {
        // Split-1, Split-2, Split-11, Split-13, Split-18 with no given “split” or
        //“num_outputs”
        net.AddLayer(new Layers.Split(node.Name, node.Input0, node.Outputs, axis,
      node.Outputs.Length));
    }
});
```

The converter module 206 can elicit and/or receive and/or automatically incorporate user input specifying a custom implementation for input operators, in the form of a custom layer specification. In some examples, the model execution system 200 automatically updates or extends the implementation of one or more of the set of internal, supported operators by incorporating user-provided input into the respective implementation. In some examples, the model execution system 200 automatically updates its set of internal, supported operators to include a set of user-supplied set of instructions or code corresponding to an additional operator, such as for example one of the input operators used by the input computational graph or an associated library (e.g., ONNX operators, etc.). Thus, an input computational graph using operators previously unsupported by the model execution system 200 can be converted to an internal computational graph by automatically eliciting and incorporating user-supplied input.

In some examples, the internal computational graph is immediately executable or runnable, while in others subsequent processing is needed. For example, the converter module 206 calls a validator module to validate the graph or AST. The validator module runs one or more validation and/or modification passes over the internal computational graph to detect broken or missing links between layers, validate partial shape inference for the shape of one or more tensor inputs, validate unique outputs, or modify the internal computational graph as needed to render it executable. For example, the converter module 206 or transpiler module 208 can determine that the internal computational graph is not executable based on at least a mismatch between the expected layer input layout for the internal computational graph, and the layer input layout corresponding to the input computational graph. The model execution system 200 can then automatically convert input tensors to the expected layout, and/or add additional layers (e.g., Pad layers, Transpose layers, etc.) in order to ensure that the logic of the internal computational graph is valid.

In an example, consider the operation:
Squeeze (3,1,2)→(3,2) corresponding to a reduction in the rank of the input tensor.

In some examples, the internal computational graph uses a NHWC tensor layout, while the input computational graph uses a NCHW tensor layout. The model execution system 200 can apply a 1-pad operation (e.g., via an added Pad layer in the internal computational graph) to the input tensor and output tensor for the Squeeze operation (e.g., here, (3,1,2) and (3,2)) tensors to have them fall into a named dimension of rank N (here, N=4). For example, Pad (3,1,2)→(3,2,1,1), while Pad (3, 2)→(3,1,1,2). Furthermore, the model execution system 200 can insert Transpose operations before/after the Squeeze layer to ensure the logic maps to the internal computational graph layout format and the manner in which the Squeeze operator is implemented.

In some examples, the transpiler module 208 analyzes the internal computational graph, and/or collects and propagate down the graph information about graph structure, layer inputs and outputs, memory requirements for executing certain layers (e.g., executing the implementation of certain operators), and so forth (see, e.g., at least FIG. 4). After the graph analysis is completed, the transpiler module 208 performs one or more optimization or modification passes over the internal computational graph or internal AST. In some examples, graph analysis operations can be performed as part of optimization or modification passes (e.g., ContractToSimplerLayerPass). Modifications or optimizations of the internal computational graph (or internal AST) include re-ordering portions of the graph to be more memory efficient, layer simplification, layer fusing (e.g., for linear layers), constant fusing, subgraph fusing, dynamic generation of layers (e.g., layer spawning), best scheduling schemes, best backend fallback determination, and so forth. Modifications or optimizations can be directed towards optimizing the general execution, or towards improving runtime execution performance on specific endpoints (see the execution module below). Modification and/or optimization passes can be independent, and/or run selectively, separately and with no restrictions on the ordering of the passes. Furthermore, the model execution system 200 ensures that any modified version of an internal computational graph or AST remains runnable (executable) after any set of optimization or modification passes, for example by running one or more validation passes as previously described.

Layer or Operator Fusing In an illustrative example, transpiler module 208 has analyzed the internal computational graph (or internal AST) and/or identified layer input and/or layer output information for one or more layers, as described above. Based on the identified layer input and/or layer output information, transpiler module 208 determines whether a layer fusing graph optimization operation can be implemented. A helper function checking a set of conditions for fusible layers is illustrated below:

```
        static bool AreLayersFusable(Layers.Layer 10, Layers.Layer 11, Dictionary<string,
        Layers.Constant> constTensors, Dictionary<string, bool> sharedConstants,
        LinearLayerFusing linearLayerFuser)
  {
      if (10.inputs.Any(i=>sharedConstants.ContainsKey(i)&&
      sharedConstants[i]))
        return false;
      if (11.inputs.Any(i=>sharedConstants.ContainsKey(i)&&
sharedConstants[i]))
        return false;
    // if input has a fused activation or if fusing code not implemented, layers cannot be fused
      return (IsLayerFusedActivation(10) &&
        linearLayerFuser.AreLayersFusable(10, 11, constTensors));
  }
```

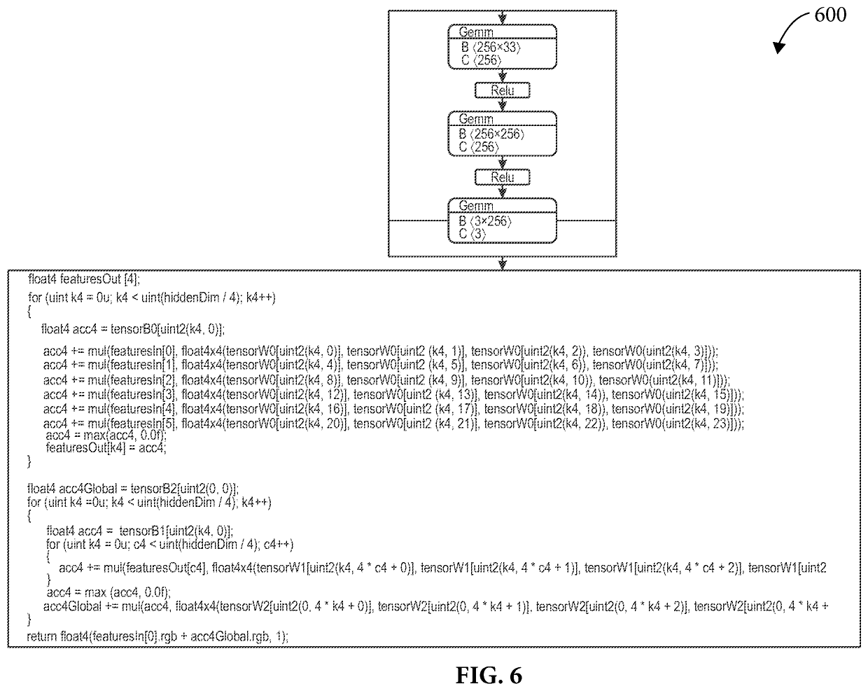

Using inferred information about layer types and/or layer inputs, the AST transpiler can correctly fuse layers. Layer fusing refers to generating new code that implements a set or collection of layers, by replacing the separate operator implementations with a newly generated implementation (see, e.g., FIG. 6).

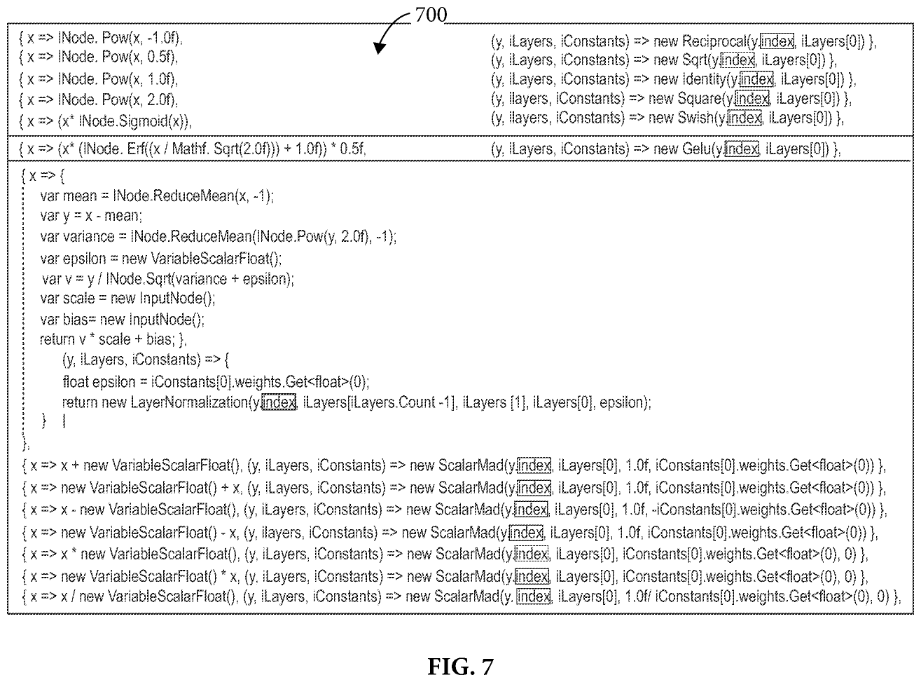

Subgraph Fusing In some examples, the transpiler module 208 analyzes the internal computational graph to detect subgraphs that map to a single operator with a known implementation, in a manner similar to a compiler recognizing a mathematical pattern and replacing it with a compact, optimized form. Detecting such subgraphs and replacing them with the corresponding operator corresponds to subgraph fusing (see, e.g., FIG. 7). In an example, MatMul(A, B)+C is a subgraph corresponding to the semantics of a General Matrix Multiply (GEMM) layer, specifically GEMM(A, B, C), and therefore it can be replaced with the GEMM layer. In another example, the transpiler module 208 can detect that the subgraph GEMM (GEMM(A, B), C)+D can be replaced by a SGEMM(A, E, F) layer, where SGEMM indicates a Single-Precision Matrix Multiplication operation and A, B, C, D, E, F are tensors. In another example, the transpiler module 208 can replace a MatMul( )+Add( ) subgraph with a replacement, spawned, SGEMM( ) layer. As seen above, the transpiler module 208 can spawn new layers in the internal computational graph, in this case corresponding to operators with known implementations.

Constant fusing In some examples, the transpiler module 208 determines that subgraphs of the internal computational graph contain only known values and/or operators. For example, consider the example subgraph below:

$$\\ {C}_{0} \to Exp \to Sqrt \to …$$

where the value of the constant C₀ is already set. Since C₀ is known, and the Exp and Sqrt layers have no additional unknown inputs, the subgraph C₀→Exp→Sqrt is fully computable independently of additional user input, and therefore can be automatically collapsed, by automatically fusing the respective layers. A transformation or collapse of a subgraph where the values of the inputs and the semantics of the operators are fully known without additional user input corresponds to constant fusing.

In another illustrative example related to constant fusing, consider the example series of operations below:

$$\\ MatMul ( ( MatMul ( Input , A ) + B ) , C ) + D$$

Here, A, B, C, D are tensors with already known values, while the value of Input is unknown until received or provided by a user. In this case, the model execution system 200 can automatically transform the above subgraph to:

$$\\ MatMul ( Input , MatMul ( A , C ) ) + MatMul ( B , C ) + D ,$$

MatMul(A,C) can be replaced, via constant fusing, with A0 (where A0 is a computed constant). MatMul(B,C)+D can be replaced, via constant fusing, with B0 (where B0 is a computed constant). Thus, the initial subgraph can be automatically replaced with a simplified form:

$$\\ MatMul ( Input , A 0 ) + B 0$$

In some examples, the transpiler module 208 can elicit and/or automatically incorporate received user input including instructions for modifying or merging layers of an internal computational graph or AST, instructions creating custom layers of an internal computational graph or AST, a specification of an execution call stack for a layer (e.g., an existing, modified, or created layer), instructions creating custom passes (e.g., optimization passes, validation passes, etc.), and so forth.

FIG. 4 is an illustration of a partial view 400 of a model execution system 200, according to some examples, corresponding to part of an import pipeline as implemented by import module 202. The example subgraph in FIG. 4 corresponds to an example fragment of an internal AST used by the model execution system 200 (see, e.g., layers corresponding to NN operators such as convolution, transpose, activation functions, etc.).

The import module 202 uses transpiler module 208 (e.g., via an AST transpiler) to perform an analysis of an internal computational graph (e.g., an internal AST) and identify global characteristics and/or local characteristics. Such characteristics can be propagated within the graph or AST (e.g., from a node to its children). In some examples, the automatic determination of these characteristics is due to the use of an internal AST structure, the use of the generic Layer class (with the associated layer types), and/or storing and propagating inferred information (whether partial information or completely inferred information). The combination of at least these factors allow for a more high-level representation than that of some input computational graphs, where the higher-level representation enables analysis and/or optimization for the internal computational graph without a runtime performance cost. In fact, the analysis and/or optimization enabled by the internal AST structure lead to improvements in execution time, as detailed throughout the disclosure.

In some examples, global characteristics include a determination of whether the internal computational graph is topologically sorted. In some examples, local characteristics include memory requirements associated with specific layers, and/or backend requirements associated with layers. Examples of such backend requirements include whether a layer should run on a CPU or a GPU, among others. For example, the transpiler module 208 can determine that a layer needs to be read on the CPU, and/or propagate this information/state/backend requirement for the specific layer to an input of the layer. In some examples, the state/information can be propagated throughout (e.g., upwards) the internal computational graph (or internal AST), using for example a reverse depth-first search. The propagation stops when the current layer being examined has no data dependency on an input tensor value. Thus, the transpiler module 208 can identify one or more layers (e.g., subgraphs) associated with a specific backend (e.g., a CPU, a GPU, etc.).

Local characteristics also include inferred information about layer properties, relationships among layers, layer inputs and/or layer outputs, and so on.

An analysis or inference example refers to automatically reasoning about partially known layer inputs and layer outputs, while potentially incorporating the semantics of specific operators or layers. For example, the transpiler module 208 performs shape inference analysis to determine partial or fully-known tensor shape information associated with layer inputs and/or layer outputs. The transpiler module 208 can also determine properties of one or more layer outputs based on pre-defined logic specific to a layer type, and/or shape information and/or tensor data information of the one or more layer inputs. Such properties of the one or more layer outputs can include partial shape information and/or fully-known (complete) shape information, and/or tensor data information for the layer output. The transpiler module 208 attempts to determine such properties for every layer type in the internal computational graph (depending on layer-specific logic).

For example, a tensor input for a Shape layer can have shape (‘N’, 3, 4), with ‘N’ corresponding to an unknown value, while the tensor output for the layer can be determined to be a tensor with shape (1, 2) and values [′N′, 3], where the determination is based on the semantics of the layer corresponding to a specific operator. In another illustrative example, given a matrix multiplication (MatMul) layer whose inputs are partially defined tensors, the transpiler module 208 uses logic that specifies what shape information that can be inferred for the output tensors of the layer.

In another illustrative example, consider a Size layer, which takes as input a tensor and outputs another tensor (e.g., an array) representing the number of elements in the input tensor (e.g., corresponding to the length of the shape of the input tensor). In some examples, the Size layer implementation includes the following:

```
  internal override void InferPartial(PartialInferenceContext ctx)
  {
      var X = ctx.GetPartialTensor(inputs[0]);
      ctx.AddPartialTensor(index, new PartialTensor(DataType.Int, new
SymbolicTensorShape( ))
          {
            [0] = (PartialTensorElement)X.shape.Length( )
          };
    }
  public override void Execute(ExecutionContext ctx)
  {
        var X = ctx.vars.GetTensor(inputs[0]);
        var O = ctx.vars.AllocateTensorAndStore(index, new TensorShape( ), DataType.Int,
ctx.backend.backendType) as TensorInt;
              BurstTensorData.Pin(O);
              O[0] = X.shape.length;
    }
```

In an illustrative example, given an input tensor with shape (‘N’, 3), where N is a variable, the output tensor of the size layer will be a partial information tensor (e.g., partial tensor) with a fully known, inferred shape (1), but without fully-known elements. Specifically, the number of input tensor elements, N*3, is not fully inferable, because the value of N is not yet known. Thus, the shape of the output tensor is inferable, even if the data is not fully inferable. The system then spawns a new dynamic dimension (e.g., ‘N3’, corresponding to 3*N).

As seen above, in some examples, the model execution system 200 implements partially defined tensors using a SymbolicTensorShape object. Such objects these can be converted to a TensorShape object if the tensor information is fully known. A Symbolic TensorShape corresponds to the shape of a tensor (e.g., an layer input) consisting of multiple dimensions, which can be fixed (e.g., known integer values) or dynamic or symbolic (denoted by a “?” or string value). For example, an input with shape (d0, 1, 28, 28) allows for any do value for the first dimension. As seen in the previous example, the model execution system 200 can use partially known tensor information, in the form of partially specified input tensor shape, to make inferences about graph layers and/or their corresponding outputs. Such inferred information can be used in further downstream inferences, for subsequent layers and/or outputs.

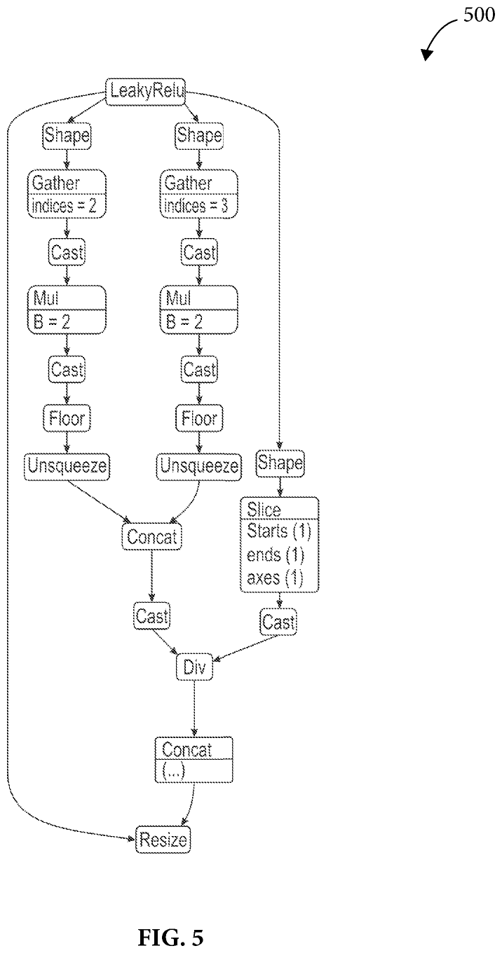

FIG. 5 is an illustration of a partial view 500 of a model execution system 200, according to some examples. FIG. 5 illustrates a subgraph of a computational graph being analyzed and/or optimized by model execution system 200. In some examples, the semantics of the layers and/or operators is available at https://docs.unity3d.com/Packages/com.unity.sentis@1.2/api/Unity.Sentis.Layers.html.

In this illustrative example, the transpiler module 208 determines that the output of the Shape layers is (N, C, H, W) for an output tensor corresponding to the LeakyRelu layer. The output values of the Gather layers given the specified indices are determined to be H (for “indices=2”), and respectively W (for “indices=3”). Continuing the analysis, the transpiler module 208 finds that the outputs of the Unsqueeze layers are (H*2), and respectively (W*2) (e.g., due to the previous Mul layers, which correspond to element-wise multiplications by 2). The output of the Concat layer will thus be (H*2, W*2). Given the (N, C, H, W) output of the Shape layer, the output of the particular Slice layer, given the illustrated parameters, is determined to be (H, W). Thus, the output of the Div layer is determined to correspond to (2, 2), which further fully determines the output of the Concat layer. Thus, in this case, the transpiler module 208 can automatically analyze a subgraph and determine that it can be further optimized—here, collapsed—in the context of known shapes and/or specific parameters.

FIG. 6 is an illustration of a partial view 600 of a model execution system 200, according to some examples. FIG. 6 illustrates an example of layer fusing. The transpiler module 208 determines that a set of GEMM layers, illustrated in the top panel of FIG. 6, can be fused as illustrated in the bottom panel of FIG. 6. Layer fusing refers to replacing a fusible set of layers (see, e.g., FIG. 4), with a set of instructions corresponding to the combined implementation of the set of layers. For example, instead of iteratively calling each layer/operator in the set of layers with corresponding inputs, retrieving the outputs and passing them as inputs to the next layer before calling the next layer/operator and so forth, the model execution system 200 takes the inputs to the first layer in the set of layer, uses them as part of the fused code, and generates the final outputs corresponding to the last layer in the set of layers. FIG. 6 illustrates the model execution system 200 fusing or combining consecutive GEMM( ) layers, together with the ReLU( ) activations (see., e.g., “acc4=max (acc4, 0.0f)”, in the bottom panel of FIG. 6).

FIG. 7 is an illustration of a partial view 700 of a model execution system 200, according to some examples. As indicated in FIG. 3, the transpiler module 208 analyzes an internal computational graph to detect subgraphs that map to a single operator with a known implementation and replace the subgraph with the single operator. FIG. 7 illustrates examples of such subgraphs and corresponding replacements. For example, a detected Pow (x, −1.0f) subgraph corresponds to the Reciprocal( ) operator (e.g., 1/x), and a corresponding Reciprocal layer can be created. In another example, a detected (x*Sigmoid (x)) subgraph corresponds to a Swish operator-upon detecting such a subgraph, a corresponding Swish layer is created.

FIG. 8 is an illustration of a partial view 800 of a model execution system 200, according to some examples, corresponding to an execution pipeline implemented by the execution module 210. The execution module 210 is responsible for executing layers of an internal computational graph (or AST), and/or the entire computational graph (or AST). The execution module 210 includes a backend interface with one or more levels of virtual abstractions that can be used to specify a backend for running the internal computational graph (or AST). Backend examples include CPU (slow), CPU (fast), GPU, NPU, TPU, Compute (e.g., ComputeShader), PixelShader, Burst, and so forth. In the context of the backend interface abstractions, Compute can map to Compute (slow), which in turn maps to a CPU (slow) backend. Compute (e.g. ComputeShader) can also map to a GPU backend. In another example, PixelShader and/or Burst can map to a CPU (slow) backend.

In some examples, each layer in the internal computational graph (or internal AST) has an associated execution graph. For example, an execution graph for the Reshape layer can be seen below:

```
Reshape layer:
  public override void Execute(ExecutionContext ctx)
  {
    var X = ctx.vars.GetTensor(inputs[0]);
    var shape =
      X.shape.Reshape(ctx.vars.GetTensor(inputs[1]). ToReadOnlySpan
          <int>( ), allow Zero);
    var O = ctx.vars.AllocateTensorAndStore(index, shape,
        X.dataType, ctx.backend.backendType);
    if (O.shape.HasZeroDims( ) return;
    ctx.backend.Reshape(X, O);
  }
```

In another example, an execution graph for the Squeeze layer can be seen below:

```
public override void Execute(ExecutionContext ctx)
{
  var X = ctx.vars.GetTensor(inputs[0]);
  TensorShape shape;
  if (inputs.Length > 1 && ctx.vars.GetTensor(inputs[1]) != null)
    {
                var axes =
                ctx.vars.GetTensor(inputs[1]).ToReadOnlySpan<int>( );
          shape = X.shape.Squeeze(axes);
            }
  else
    {
              shape = X.shape.Squeeze( );}
        var O = ctx.vars.AllocateTensorAndStore(index,
                  shape, X.dataType, ctx.backend.backendType);
          if (O.shape.HasZeroDims( )) return;
          ctx.backend.Reshape(X, O); // TODO<tensordata>
                    //refcount tensordata
      }
```

As indicated above, each layer has an associated execution graph. The layer and/or its associated execution graph relies on one or more backend implementations for an operator. In some examples, multiple layers can have execution graphs using a shared backend-specific operator (e.g., primitive) implementation, although the semantics of the execution graphs, associated with the semantics of the layers, are different. The set of instructions corresponding to an implementation of an operator (e.g., a logical operator) on a backend is known as a kernel. In some examples, an operator can have implementations on multiple backends, incorporating backend-specific optimizations. In some examples, an operator can have multiple potential implementations on a backend, depending on the semantics of the operator and characteristics of the inputs. The selection of a backend and/or of a high-performance associated kernel for the specific backend can be done at runtime (see, e.g., the Kernel Caching example discussion for a matrix multiplication example).

In some examples, the internal computational graph can be partitioned into subgraphs such that a first set of subgraphs are optimized for execution on a first backend (e.g., a GPU), and a second set of subgraphs are optimized for execution on a second backend (e.g., a CPU), and so forth. The partitioning is done to optimize an execution of the graph. For example, a high-performance or optimal partitioning can depend on layer and/or output readback requirements. Layer readback requirements refer to minimizing or eliminating readback from a GPU to a CPU, a slow process that can include interrupting an application and/or frame. In some examples, the first set of subgraphs to be executed on the GPU does not need to be read back to the CPU. In some examples, if an application needs to read back a particular layer from the CPU (e.g., a user specifies that an output should be read on the CPU), load balancing can be applied to the graph execution to ensure that the output is on the CPU at the end. In some examples, dynamic, small layers (corresponding to shape operations, operations involving small tensors or I/O heavy subgraphs), can be assigned to a CPU. For example, operations and/or layers including Resize, Squeeze, Reduce (input 2) are illustrative examples of layers whose output should be on the CPU for a readback mid scheduling. Heavy layers can be assigned for execution to a GPU. In some examples, partitioning includes using the Pin mechanism to dynamically switch the location of the tensor data to and from a given backend.

In some examples, a variety of operators (e.g., every NN operator) have a Burst code implementation and/or a ComputeShader implementation (e.g., among other backend-specific implementations). Given an internal computational graph or internal AST, the execution module 210 can produce shader code corresponding to executing the operations of an imported and/or optimized model (e.g., a NN model), and/or scheduling instructions. In some examples, the execution module 210 uses a compiler (e.g., a Burst compiler, a UnityShaderCompiler etc.) to compile backend-specific code (e.g., shader code), the compiled code to be executed on a target platform and/or engine (e.g., PS4, Microsoft Windows, IOS, Android, WebGL). In some examples, the shader code and the scheduling instructions can be automatically converted or automatically ported to code corresponding to a native API (e.g., native graphics API) of a target platform, which allows the internal computational graph (e.g., internal AST) to run on the target platform.

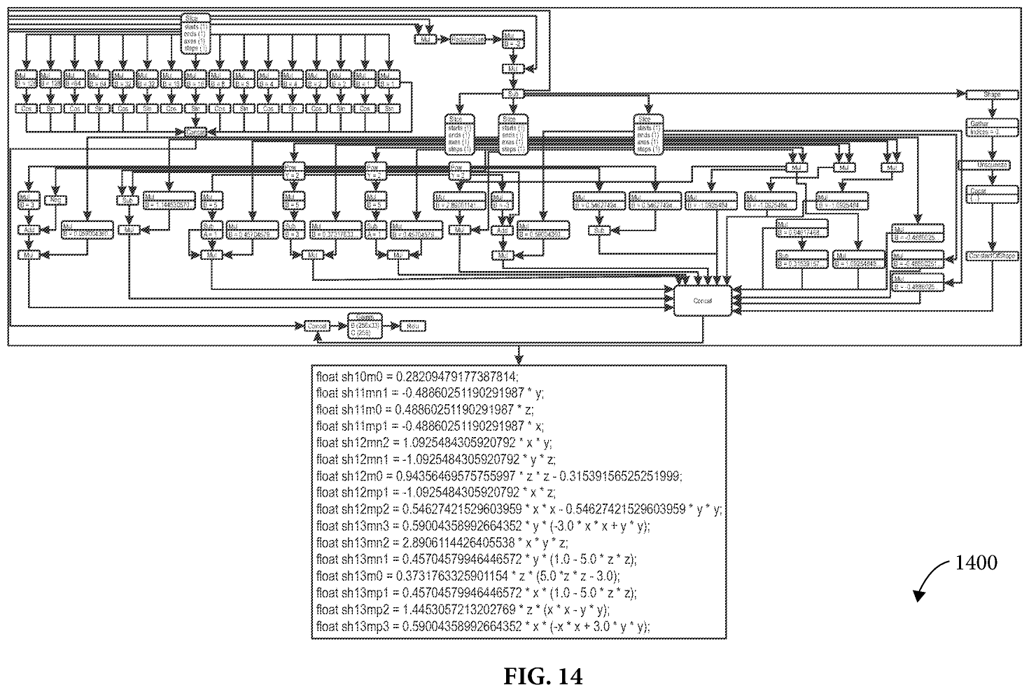

Thus, model execution system 200 can convert an imported computational graph to an internal computational graph (or AST), compile the internal computational graph (or AST) to shader code and/or scheduling instructions, and/or cross-compile or convert the shader code and/or scheduling instructions in the context of a target platform's native API. The model execution system 200 can generate an execution artifact (e.g., the cross-compiled code) that is independent from any internal representation, function or capability of the model execution system 200, and/or can be executed or repurposed outside of the model execution system 200, for example as part of a new system, engine or platform. In other words, execution module 210 can “bake down” or convert an internal computational graph (or AST) to an easily reusable output file (see, e.g., FIG. 14).

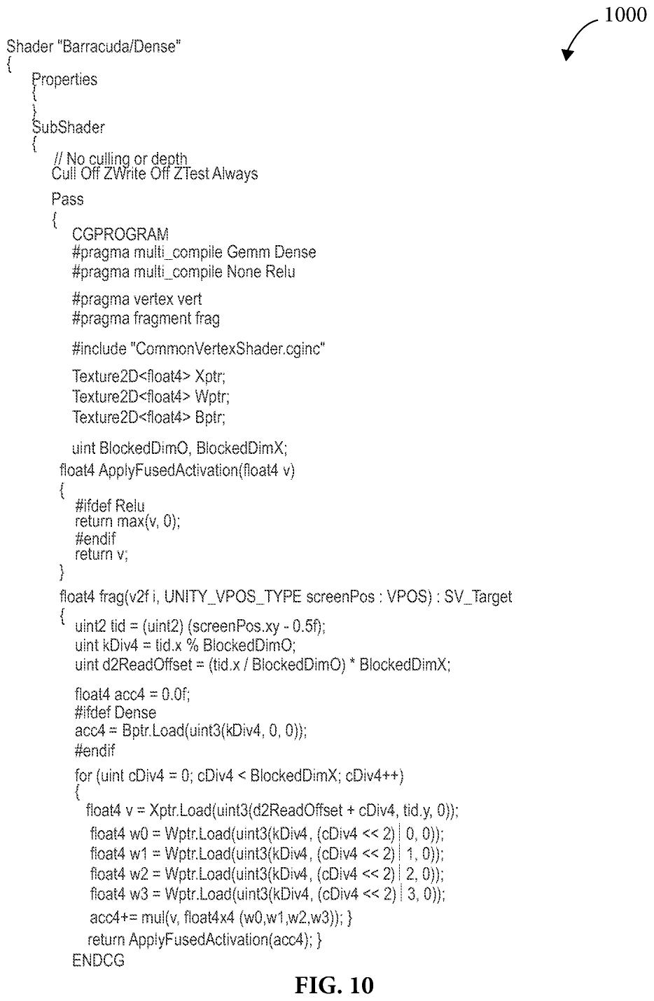

In an example, a model represented by a ONNX file may need to be run on a platform using Three.js or OpenGL. Internal computational graph operators (such as matrix multiplication) have corresponding generated shader code (e.g., in “.shader” files) whose syntax and semantics are close to code using a native API of the platform (see, e.g., FIG. 10, where MatMul code is close to OpenGL code). The execution module 210 can automatically convert shader code and/or associated scheduling instructions code into code using native API functions for a target platform (e.g., OpenGL files). The model execution system 200 can also include support for a developer-authored conversion/porting of shader code and/or scheduling instructions code into code using native API functions for a target platform or engine.

In some examples, the execution module 210 includes a worker factory module and/or associated application programming interface (API), for specifying inputs, scheduling the work and/or retrieving outputs. For example, upon receiving a loaded and/or optimized internal computational graph corresponding to an input model, and/or a target backend and/or a target hardware device or hardware device type for model execution, the worker factory module creates worker jobs. An example worker job translates the internal computational graph representation (or AST) into a set of operations or code instructions to be executed on the specified target backend and/or the target hardware devices. The internal computational graph can be scheduled and executed as a whole, or at the level of individual layers (or sets of layers). The worker factor module uses a worker class representation (e.g., IWorker) that abstracts implementation details related to target hardware devices.

Example backend-specific kernels can require a particular input tensor layout to be more efficient. Generating the required tensor layout is handled directly, at run time, by the functions implementing operators for specific backends (e.g., Burst.CPU), regardless of input tensor layout. The model execution system 200 can use a tensor class or structure (e.g., Tensor) with a tensor data field that allows for backend-dependent representation of tensor data (e.g., ITensorData, with associated types or subclasses BurstTensorData, ComputeTensorData, etc.). An example BurstTensorData object specifies internal storage for tensor data (e.g., Tensor) that is specific to a Burst-type backend. The execution module 210 supports functions (e.g. Pin( ) that allow each type of tensor or tensor data to have a fast path conversion to other tensor or tensor data types (e.g., converting to a desired BurstTensorData or Compute TensorData type, etc.). If an efficient implementation of an operator for a backend needs a tensor with a particular layout, a Pin (tensor) call will convert the tensor to the needed layout, or consist of a “pass through” if the tensor layout is already as required. For example, given a Burst.CPU backend implementation, Pin (tensor) is a function that “pins” a tensor to the Burst (or Burst.CPU) backend by converting the tensor to a BurstTensorData object specifying Burst-specific internal storage for the tensor. In an illustrative example of a convolution (Conv) operator and a Burst.CPU backend, the execution module 210 can use a Pin( ) function as illustrated below in the course of preparing and/or scheduling a worker job on the targeted backend:

```
Conv(TensorFloat X, TensorFloat K, TensorFloat B ...)
  var Oshape = ShapeInference.Conv(X.shape, K.shape,B.shape, ...)
  ...
var job = new ConvJob( );
int arrayLength = job.Prepare(X.shape, K.shape, O.shape, ...)
job.ScheduleXSBO(Pin(X), Pin(K), Pin(B), Pin(O ...)...)
```

In some examples, the same or equivalent functions “pin” a tensor to alternative backends (e.g., by converting it to a ComputeTensorData object in the case of a Compute backend, and so forth).

The model execution system 200 (e.g., via the execution module 210) implements a number of additional optimizations. For example, the model execution system 200 can implement automatic weight quantization (e.g., FP16 quantization, uint8 quantization, 1.5 bit quantization). In some examples, the model execution system 200 imports a trained ML model, and therefore it can implement post-training quantization for the associated model weights in order to reduce model size and/or improve execution efficiency (e.g., in some examples, the weight quantization can be implemented by the converter module 206). Other optimizations are detailed below.

### Example Optimization: Kernel Caching

The model execution system 200 can implement, via the execution module 210, kernel caching. Kernel caching refers to caching a mapping between at least a characteristic of the shape of a layer input and a kernel choice or kernel specification for the respective layer. For example, consider the case of a matrix multiplication operator and/or layer. There are multiple types of matrix multiplication implementations, each corresponding to different types of inputs. For instance, multiplying a N×M matrix and a M×K matrix corresponds to matrix-matrix multiplication, while multiplying a 1×N matrix and N×M matrix corresponds to a vector-matrix multiplication, a type of matrix-matrix multiplication that can be implemented in an optimized fashion. Other matrix multiplication types, each with a specific implementation, include a multiplication of a matrix by a scalar, a batched matrix multiplication operation, and so forth. Thus, different matrix multiplication types, determined based by the shapes of their inputs, can be associated with different kernels (implementations). Each implementation can be further optimized based on determining information associated with an endpoint, such as the streaming processor wave size of an endpoint GPU (as further seen below). In some examples, given a layer/operator of the internal computational graph that has multiple potential implementations, the selection of the optimal kernel for the operator is done at runtime, which incurs overhead. However, the execution module 210 can reduce the overhead by caching a mapping between a) one or more characteristics of one or more inputs for the operator/layer (e.g., layer input shape, indicator of whether layer shape elements for input are multiples of a wave size, etc.) and, b) the optimal kernel to be used. The reduced overhead due to caching can include selection time and/or code compilation time.

As mentioned above, the execution module 210 further optimizes kernels (e.g., endpoint specific kernels). For example, the model execution system 200 can determine information associated with the endpoint, such as the streaming processor wave size of an endpoint GPU and/or maximum number of resident blocks per physical streaming processor. The wave size (e.g., warp size for NVIDIA GPUs) indicates a predetermined number of synchronous threads (e.g., warp size of 32 for NVIDIA). Instructions/commands are SIMD-synchronous within a warp, which means that within a warp of the predetermined size there is no need, for example, for a syncthreads( ) operation, or for other additional checks. Therefore, the implementations corresponding to the endpoint-specific kernels can be further optimized based on the known or inferred hardware limitations, leading to faster execution times. In another example related to the discussion above, consider a kernel associated with a matrix multiplication operator. The execution module 210 can further optimize the kernel based on whether one or more the dimensions of the input tensors are multiples of the wave size (e.g., 64 for an AMD GPU, etc.), in which case a number of checks (e.g., bound checks) can be omitted, leading to a faster implementation.

### Example Optimization: Dynamic Memory Reuse

In some examples, the execution module 210 implements a dynamic memory re-use method in order to optimize memory allocation during the execution of the internal computational graph. The memory re-use method is based on maintaining a pool of tensors, each tensor previously allocated by a layer in the graph. Given a subsequent layer that needs to use a tensor, the execution module 210 checks whether a previously allocated tensor whose shape fits the needs of the subsequent layer is available in the pool of tensors. If so, the respective tensor can be re-used, in this case by the subsequent layer. If not, a new tensor will be allocated to fit the needs of the subsequent layer. When a layer is done using a pool tensor, the tensor is released into the pool. When a layer is done using a newly allocated tensor (e.g., not previously in the pool), the tensor can be added to the pool as well.

In some examples, the tensor pool is maintained as a list of tensors sorted by their associated buffer size (e.g., in bytes)—in other words, as a pool of available buffers of different sizes. Given an input size (corresponding to the allocation needs of a subsequent layer), the execution module 210 retrieves the smallest buffer whose size is greater or equal to the input size. For example, consider a pool of buffers with the following size: [1, 4, 6, 9, 11]. Given an input buffer size of 3, the execution module 210 will return the tensor and/or buffer with associated size 4 for the required use by the subsequent layer.

In some examples, the pool of tensors/buffers can be maintained using Red-Black tree data structure, which enables fast storage as well search and retrieval of buffers based on a desired input size. In some examples, the pool of tensors/buffers can be associated with a list of buffers sorted by buffer size. The execution module 210 can use binary search to identify the positive index of an input value (e.g., an input buffer size), if an available tensor and/or buffer with the respective size exists in the pool. Otherwise, the execution module 210 returns the bitwise complement of the index of tensor and/or buffer with the first buffer size that is greater than the input buffer size. If a buffer matching either of these conditions is found, the buffer is removed from the sorted list. If no such buffer is found, the execution module 210 returns a null value, in which case a tensor fitting the specific needs will be newly allocated.

In some examples, the execution module 210 can use the following data structures: a list of tensor/buffer sizes for the available tensors/buffers in the pool, and/or a dict (a dictionary data structure) for efficient retrieval and/or insertion of buffers. The pool can have multiple buffers of the same size, thus buffer size cannot be used to index buffers in the dict data structure. For each buffer size in the pool, the execution module 210 keeps track of the number of pool buffers with the respective size (e.g., size.count). The execution module 210 generates a unique key based on the buffer size and the number of pool buffers with the respective buffer size (e.g., size count). When a new tensor and/or buffer with the respective size is added to the pool, size.count is incremented, the corresponding unique key is generated, and the buffer can be added to the dict. When the execution module 210 removes or retrieves a tensor/buffer of the respective size, in response to a request from a layer as seen above, the latest inserted tensor/buffer of the respective size is retrieved from the dict. The retrieval uses a uniquely generated key based on the respective buffer size and the highest available size.count for the respective buffer size, after which the size.count is decremented to mark the removal of the buffer of the respective buffer size.

In some examples, backend-specific operator implementations and/or job scheduling instructions can be automatically generated by the model execution system 200 as part of a code generation capability. For example, the model execution system 200 can access C# code for a specific kernel and automatically convert the C# code to Compute or Burst code, as needed.

The model execution system 200 can provide APIs for custom data wrapping (e.g., enabling the creation of ITensorData objects by users). As indicated above, the model execution system 200 can automatically convert such user-created tensors to backend and/or device-specific tensor data representations (e.g. ComputeTensor Data, BurstTensorData). Thus, the model execution system 200 enables users to pipe tensors to a custom job targeting a specific backend (e.g., custom Burst job, custom Compute shaders or textures, and so forth).

In some examples, the model execution system 200 enables the use of implemented operators to perform mathematical operations independent of any model execution. This functionality enables uses to more easily write and execute separate, custom tensor logic, in a manner similar to the use of libraries like NumPy, Torch, PyTorch, etc. Users can create new tensors, perform operations (e.g., call op.Add(tensor1, tensor2) to perform an Add operation), and so forth. Since supported backends all implement operators supported by the model execution system 200, users can create such operations or tensor logic on the backend of their choice (e.g., Burst, Compute, etc.).

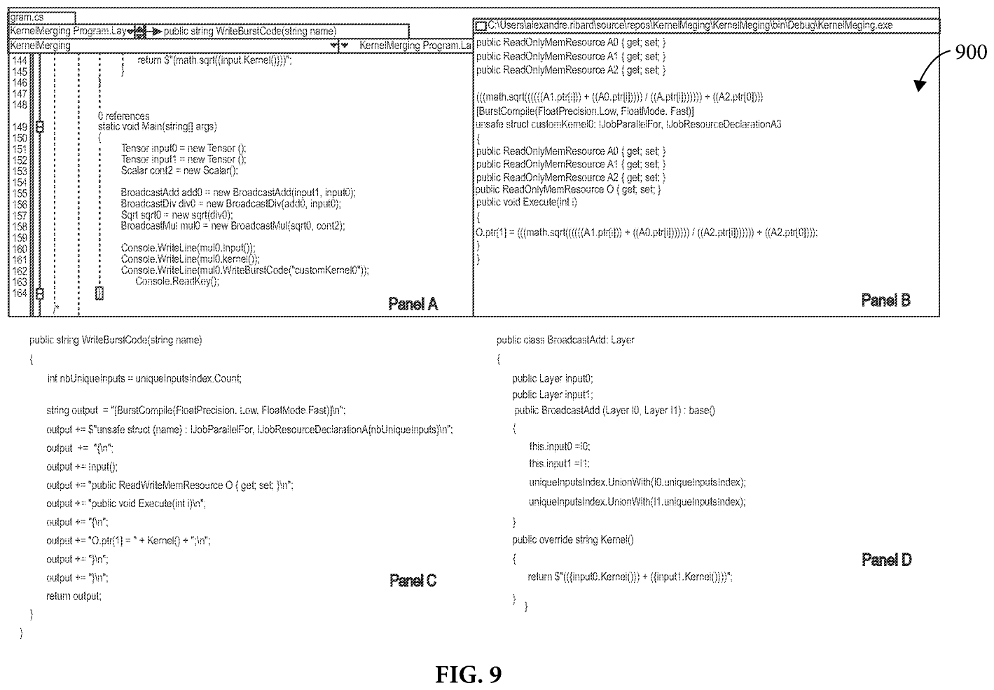

FIG. 9 is an illustration of a partial view 900 of a model execution system 200, according to some examples. The model execution system 200 can automatically generate, based on the internal computational graph or AST, a single file (e.g., a single shader file) that executes the entire graph in one execution or dispatch, rather than performing multiple dispatches, one for each individual kernel. By performing only one dispatch, rather than multiple dispatches, the model execution system 200 can achieve improved latency. The automatic generating of the code for running the single execution of the entire graph (or in, some examples, subgraph) is referred to as kernel fusing. In some examples, the model execution system 200 (e.g., at the execution module 210) chains or iteratively merges kernels corresponding to the layers of the internal computational graph in a manner similar to automatic differentiation.

Panel A in FIG. 9 shows example representative code (see, e.g., Main( ) that chains kernels corresponding to internal computational graph layers and their associated operators (BroadcastAdd, BroadcastDiv, Sqrt, BroadcastMul, etc.). As seen in Panel A, the final computed kernel associated with the BroadcastMul mul0 layer is derived by successively merging or fusing kernels associated with the previous layers. As an illustrative example, BroadcastAdd in Panel D illustrates how a kernel string associated with this layer or operator can be computed based on the retrieved kernels associated with its input layers (e.g., “input0.Kernel,” “input1.Kernel”) and the semantics of the BroadcastAdd layer itself (e.g., “+”). Kernels can be similarly derived for the other layers based on input kernels and the semantics of the layers.

In some examples, a kernel associated with a layer can be automatically converted to backend-specific code. Panels A and C illustrate how the final kernel associated with BroadcastMul mul0 can be automatically converted to BurstCode to generate “customKernel0”, a Burst-specific kernel, as seen in Panel B.

FIG. 10 is an illustration of a partial view 1000 of a model execution system 200, according to some examples. FIG. 10 illustrates a shader file associated with a kernel (e.g., implementation code) for a matrix multiplication operator (implemented by the Dense layer) on the PixelShader backend (see, e.g. com.unity.barracuda\Barracuda\Runtime\Core\Resources\Barracuda\PixelShaders\Dense.shader.)

As discussed at least in FIG. 8, such code can be converted by the execution module 210 to code using a native API of a desired platform, system, or engine. In one example, the matrix multiplication code illustrated here is close to code using the OpenGL API, so the execution modules 210 can automatically generate the corresponding OpenGL code, allowing this operator implementation to run on a variety of platforms.

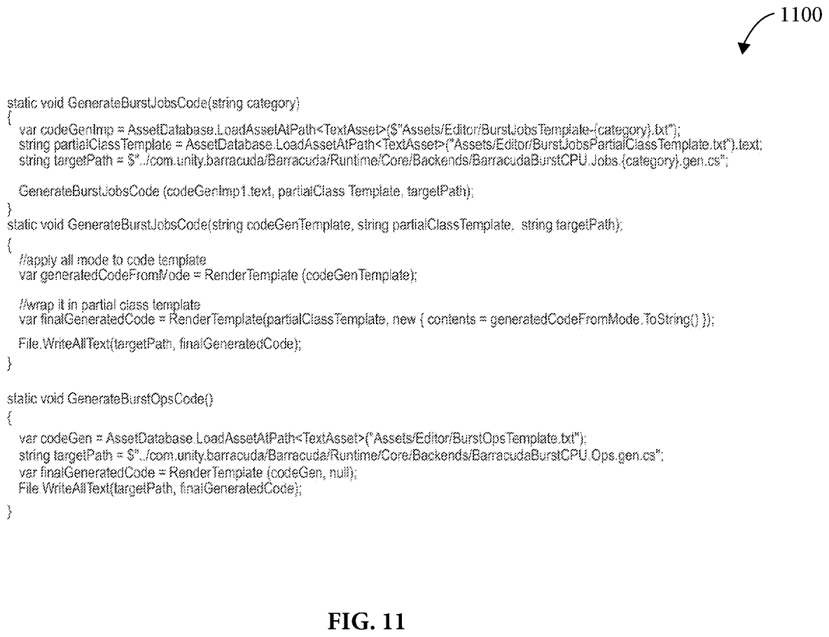

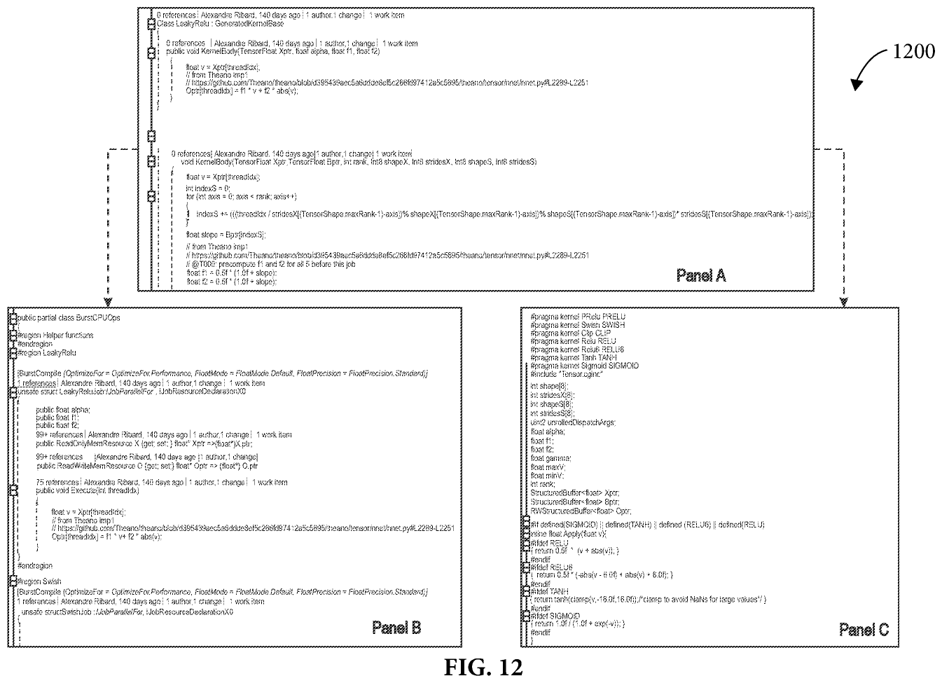

FIG. 11 is an illustration of a partial view 1100 of a model execution system 200, according to some examples. In some examples, one or more of the operator implementations, or the job scheduling instructions, are automatically generated. FIG. 11 illustrates an excerpt from a code generation procedure for Burst code (e.g., UnityProject\Assets\Editor\CodegenBurstOnly.cs) that uses template files for job and/or operator creation (e.g., BurstJobsTemplate-Activation.cs, BurstJobsTemplate-Pool.cs, BurstOpsTemplate.txt). Operator implementations and/or job scheduling instructions for Compute backends can also be automatically generated (e.g., using template files such as ComputeShaders Template-Reduction.txt, ComputeOpsTemplate.txt). An example of automatically generated Compute code can be seen in FIG. 12 (e.g., Panel C, coresponding to com.unity.barracuda\Barracuda\Runtime\Core\Resources\Barracuda\BarracudaReferenceImpl. ActivationA.gen.compute).

FIG. 12 is an illustration of a partial view 1200 of a model execution system 200, according to some examples. The execution module 210 can automatically convert a kernel written in C# code to Compute or Burst code. The execution module 210 can convert Compute code to Burst code and viceversa. Furthermore, the execution module 210 can convert Computer or Burst code to platform-specific code using a particular API (e.g., a graphics API), which allows the converted code to run on the specific platform as part of, or in conjunction with, a specific engine (e.g., a graphics engine).

Panel A in FIG. 12 corresponds to a sample of a C# code kernel. The C# code is converted automatically to corresponding Burst code, illustrated by Panel B (corresponding to UnityInferenceEngine\com.unity.barracuda\Barracuda\Runtime\Core\Backends\BarracudaBurst CPU.Jobs.ActivationA.gen.cs), or to corresponding Compute code, illustrated by Panel C (corresponding to com.unity.barracuda\Barracuda\Runtime\Core\Resources\Barracuda\BarracudaReferenceImpl. ActivationA.gen.compute). In some examples, the conversion is handled by third-party APIs and/or libraries (e.g., for example, the Rosyln C# compiler).

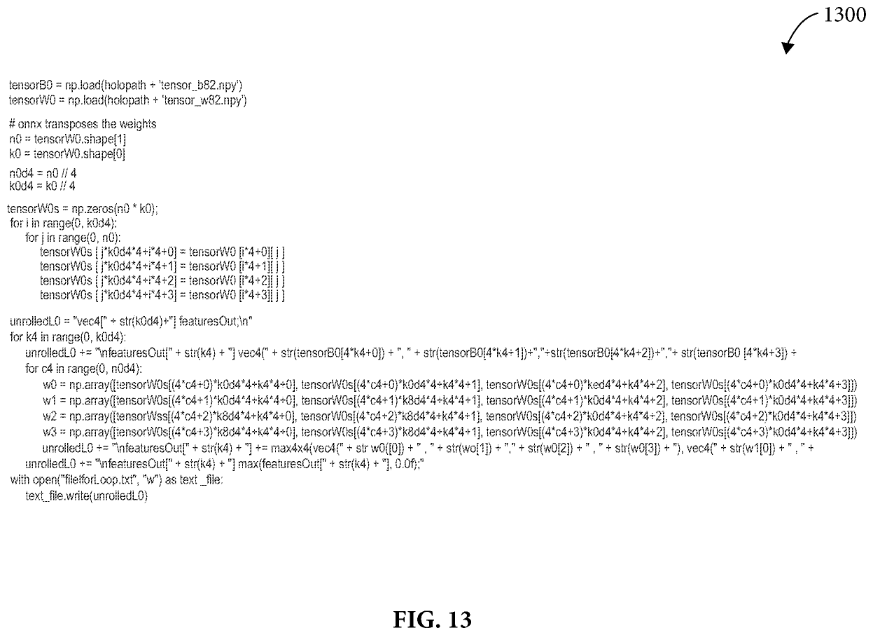

FIG. 13 is an illustration of a partial view 1300 of a model execution system 200, according to some examples. The model execution system 200 can automatically convert an internal computational graph (or AST) to a file (e.g., a shader file) using operations similar to automatic differentiation and/or using operator properties (see, e.g., FIG. 7). In some examples, the model execution system 200 incorporates available weights directly in the shader for increased efficiency (e.g., “bakes out” weights). FIG. 13 illustrates a snippet of an example method including unrolling weights associated with a matrix multiplication operator or layer as part of generating a single output shader file for a computational graph (see, e.g., w0[0], w0[1], w0[2], w0[3], etc.) In some examples, the shader code or file being generated in FIG. 13 can be based on the implementation for a matrix multiplication operation illustrated in FIG. 10.

FIG. 14 illustrates a partial view 1400 of a model execution system 200, according to some examples. The top panel in FIG. 14 illustrates a partial view of a computational graph that is transformed or “baked down” by the model execution system 200 to a set of instructions illustrated, in a partial view, in the bottom panel of FIG. 14. Thus, the model execution system 200 can convert a computational graph to a one or more files that that no longer include artifacts (e.g., code, internal representations, etc.) specific to the model execution system 200, and can be easily repurposed (e.g., executed on target platforms or integrated in other systems or engines). Furthermore, in some examples, the model execution system 200 incorporates weights directly in resulting execution code for increased efficiency (e.g., “bakes out” weights), as seen in the bottom panel of FIG. 13.

FIG. 15 is a flowchart illustrating a method 1500 as implemented by the model execution system 200, according to some examples. At operation 1502, the model execution system 200 accesses an input computational graph corresponding to a trained machine-learning (ML) model. At operation 1504, the model execution system 200 converts the input computational graph into an internal computational graph corresponding to an internal representation for the trained ML model. At operation 1506, the model execution system 200 determines characteristics of the internal computational graph. At operation 1508, based on the determined characteristics, the model execution system 200 optimizes the internal computational graph to generate an optimized computational graph by applying one or more of at least a graph element reordering operation, a graph element fusing operation, or a graph element creation operation. At operation 1510, the model execution system 200 converts the optimized computational graph to executable instructions enabled to be executed on an endpoint associated with a backend and a platform. At operation 1512, the model execution system 200 generates scheduling instructions associated with the executable instructions. At operation 1514, the model execution system 200 executes the executable instructions on the endpoint based on the scheduling instructions.

FIG. 16 illustrates a partial view 1600 of a model execution system 200, according to some examples. FIG. 16 provides an example of user-defined model code (e.g., specifying a neural network, etc.) that can be imported by the model execution system 200. The model execution system 200 automatically converts the code into an internal computational graph (or internal AST), and proceeds with the downstream components of the import pipeline and/or export pipelines, such as the transpiler module 208-enabled optimization, the execution module 210, and so forth.

FIG. 17 is a block diagram illustrating components of a machine 1700, according to some example embodiments, able to read instructions from a machine-readable medium (e.g., a machine-readable storage medium) and perform any one or more of the methodologies discussed herein. Specifically, FIG. 17 shows a diagrammatic representation of the machine 1700 in the example form of a computer system, within which instructions 1710 (e.g., software, a program, an application, an applet, an app, or other executable code) for causing the machine 1700 to perform any one or more of the methodologies discussed herein may be executed. As such, the instructions 1710 may be used to implement modules or components described herein. The instructions 1710 transform the general, non-programmed machine 1700 into a particular machine 1700 to carry out the described and illustrated functions in the manner described. In alternative embodiments, the machine 1700 operates as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1710, sequentially or otherwise, that specify actions to be taken by machine 1700. Further, while only a single machine 1700 is illustrated, the term “machine” shall also be taken to include a collection of machines that individually or jointly execute the instructions 1710 to perform any one or more of the methodologies discussed herein.

The machine 1700 may include processors 1704, memory/storage 1706, and I/O components 1718, which may be configured to communicate with each other such as via a bus 1702. The memory/storage 1706 may include a memory 1714, such as a main memory, or other memory storage, and a storage unit 1716, both accessible to the processors 1704 such as via the bus 1702. The storage unit 1716 and memory 1714 store the instructions 1710 embodying any one or more of the methodologies or functions described herein. The instructions 1710 may also reside, completely or partially, within the memory 1714 within the storage unit 1716, within at least one of the processors 1704 (e.g., within the processor's cache memory), or any suitable combination thereof, during execution thereof by the machine 1700. Accordingly, the memory 1714 the storage unit 1716, and the memory of processors 1704 are examples of machine-readable media.

The I/O components 1718 may include a wide variety of components to receive input, provide output, produce output, transmit information, exchange information, capture measurements, and so on. The specific I/O components 1718 that are included in a particular machine 1700 will depend on the type of machine. For example, portable machines such as mobile phones will likely include a touch input device or other such input mechanisms, while a headless server machine will likely not include such a touch input device. It will be appreciated that the I/O components 1718 may include many other components that are not shown in FIG. 11. The I/O components 1718 are grouped according to functionality merely for simplifying the following discussion and the grouping is in no way limiting. In various example embodiments, the I/O components 1718 may include output components 1726 and input components 1728. The output components 1726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1718 may include biometric components 1730, motion components 1734, environmental environment components 1736, or position components 1738 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1734 may include acceleration sensor components (e.g., accelerometer), gravitation sensor components, rotation sensor components (e.g., gyroscope), and so forth. The environment components 1736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1738 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1718 may include communication components 1740 operable to couple the machine 1700 to a network 1732 or devices 1720 via coupling 1722 and coupling 1724 respectively. For example, the communication components 1740 may include a network interface component or other suitable device to interface with the network 1732. In further examples, communication components 1740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1720 may be another machine or any of a wide variety of peripheral devices (e.g., a peripheral device coupled via a Universal Serial Bus (USB)).

Moreover, the communication components 1740 may detect identifiers or include components operable to detect identifiers. For example, the communication components 1740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1740, such as, location via Internet Protocol (IP) geo-location, location via Wi-Fi® signal triangulation, location via detecting a NFC beacon signal that may indicate a particular location, and so forth.

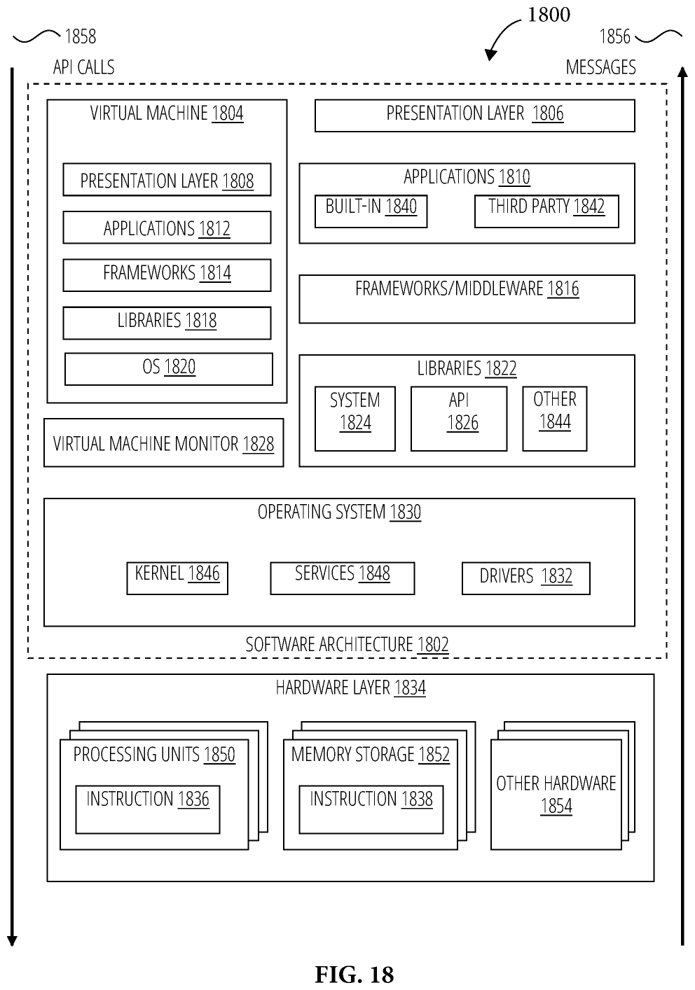

FIG. 18 is a block diagram illustrating an example of a software architecture 1802 that may be installed on a machine, according to some example embodiments. FIG. 18 is merely a non-limiting example of software architecture, and it will be appreciated that many other architectures may be implemented to facilitate the functionality described herein. The software architecture 602 may be executing on hardware such as a machine 1700 of FIG. 17 that includes, among other things, processors 1704, memory/storage 1706, and input/output (I/O) components 1518. A representative hardware layer 1834 is illustrated and can represent, for example, the machine of FIG. 17. The representative hardware layer 1834 comprises one or more processing units 1850 having associated executable instructions 1836. The executable instructions 1836 represent the executable instructions of the software architecture 1802. The hardware layer 1834 also includes memory or memory storage 1852, which also have the executable instructions 1838. The hardware layer 1834 may also comprise other hardware 1854, which represents any other hardware of the hardware layer 1834 such as the other hardware illustrated as part of the machine 1700.

In the example architecture of FIG. 18, the software architecture 1802 may be conceptualized as a stack of layers, where each layer provides particular functionality. For example, the software architecture 1802 may include layers such as an operating system 1830, libraries 1818, frameworks/middleware 1816, applications 1810, and a presentation layer 1808. Operationally, the applications 1810 or other components within the layers may invoke API calls 1858 through the software stack and receive a response, returned values, and so forth (illustrated as messages 1856) in response to the API calls 1858. The layers illustrated are representative in nature, and not all software architectures have all layers. For example, some mobile or special-purpose operating systems may not provide a frameworks/middleware 1816 layer, while others may provide such a layer. Other software architectures may include additional or different layers.

The operating system 1830 may manage hardware resources and provide common services. The operating system 1830 may include, for example, a kernel 1846, services 1848, and drivers 1832. The kernel 1846 may act as an abstraction layer between the hardware and the other software layers. For example, the kernel 1846 may be responsible for memory management, processor management (e.g., scheduling), component management, networking, security settings, and so on. The services 1848 may provide other common services for the other software layers. The drivers 1832 may be responsible for controlling or interfacing with the underlying hardware. For instance, the drivers 1832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1818 may provide a common infrastructure that may be utilized by the applications 1810 and/or other components and/or layers. The libraries 1818 typically provide functionality that allows other software modules to perform tasks in an easier fashion than by interfacing directly with the underlying operating system 1830 functionality (e.g., kernel 1846, services 1848 or drivers 1832). The libraries 1818 may include system libraries 1818 (e.g., C standard library) that may provide functions such as memory allocation functions, string manipulation functions, mathematic functions, and the like. In addition, the libraries 1818 may include API libraries 1028 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1818 may also include a wide variety of other libraries 1822 to provide many other APIs to the applications 1810 or applications 1812 and other software components/modules.

The frameworks 1814 (also sometimes referred to as middleware) may provide a higher-level common infrastructure that may be utilized by the applications 1810 or other software components/modules. For example, the frameworks 1814 may provide various graphical user interface functions, high-level resource management, high-level location services, and so forth. The frameworks 1814 may provide a broad spectrum of other APIs that may be utilized by the applications 1810 and/or other software components/modules, some of which may be specific to a particular operating system or platform.

The applications 1810 include built-in applications 1840 and/or third-party applications 1842. Examples of representative built-in applications 1840 may include, but are not limited to, a home application, a contacts application, a browser application, a book reader application, a location application, a media application, a messaging application, or a game application.

The third-party applications 1842 may include any of the built-in applications 1840 as well as a broad assortment of other applications. In a specific example, the third-party applications 1842 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1842 may invoke the API calls 1858 provided by the mobile operating system such as the operating system 1830 to facilitate functionality described herein.

The applications 1810 may utilize built-in operating system functions, libraries (e.g., system libraries 1824, API libraries 1826, and other libraries), or frameworks/middleware 1816 to create user interfaces to interact with users of the system. Alternatively, or additionally, in some systems, interactions with a user may occur through a presentation layer, such as the presentation layer 1808. In these systems, the application/module “logic” can be separated from the aspects of the application/module that interact with the user.

Some software architectures utilize virtual machines. In the example of FIG. 18, this is illustrated by a virtual machine 1804. The virtual machine 1804 creates a software environment where applications/modules can execute as if they were executing on a hardware machine. The virtual machine 1804 is hosted by a host operating system (e.g., the operating system 1830) and typically, although not always, has a virtual machine monitor 1828, which manages the operation of the virtual machine 904 as well as the interface with the host operating system (e.g., the operating system 1830). A software architecture executes within the virtual machine 1804, such as an operating system 1830, libraries 1818, frameworks/middleware 1816, applications 1812, or a presentation layer 1808. These layers of software architecture executing within the virtual machine 1804 can be the same as corresponding layers previously described or may be different.

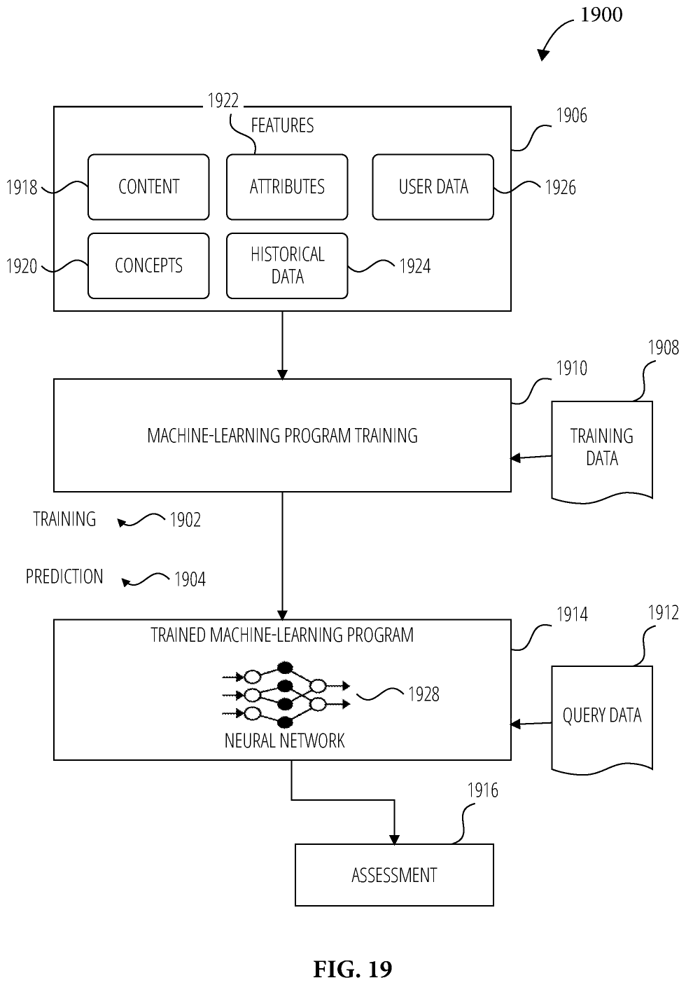

FIG. 19 is a block diagram showing a machine-learning program 1900 according to some examples. The machine-learning programs 1900, also referred to as machine-learning algorithms or tools, are used to train machine learning models, which are imported by the model execution system 200, as described in FIG. 2.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1908 in order to make data-driven predictions or decisions expressed as outputs or assessments (e.g., assessment 1916). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1900 supports two types of phases, namely a training phase 1902 and prediction phase 1904. In a training phase 1902, supervised learning, unsupervised or reinforcement learning may be used. For example, the machine-learning program 1900 (1) receives features 1906 (e.g., as structured or labeled data in supervised learning) and/or (2) identifies features 1906 (e.g., unstructured or unlabeled data for unsupervised learning) in training data 1908. In a prediction phase 1904, the machine-learning program 1900 uses the features 1906 for analyzing query data 1912 to generate outcomes or predictions, as examples of an assessment 1916.

In the training phase 1902, feature engineering is used to identify features 1906 and may include identifying informative, discriminating, and independent features for the effective operation of the machine-learning program 1900 in pattern recognition, classification, and regression. In some examples, the training data 1908 includes labeled data, which is known data for pre-identified features 1906 and one or more outcomes. Each of the features 1906 may be a variable or attribute, such as individual measurable property of a process, article, system, or phenomenon represented by a data set (e.g., the training data 1908). Features 1906 may also be of different types, such as numeric features, strings, and graphs, and may include one or more of content 1918, concepts 1920, attributes 1922, historical data 1924 and/or user data 1926, merely for example.

In training phases 1902, the machine-learning program 1900 uses the training data 1908 to find correlations among the features 1906 that affect a predicted outcome or assessment 1916.

With the training data 1908 and the identified features 1906, the machine-learning program 1900 is trained during the training phase 1902 at machine-learning program training 1910. The machine-learning program 1900 appraises values of the features 1906 as they correlate to the training data 1908. The result of the training is the trained machine-learning program 1914 (e.g., a trained or learned model).

Further, the training phases 1902 may involve machine learning, in which the training data 1908 is structured (e.g., labeled during preprocessing operations), and the trained machine-learning program 1914 implements a relatively simple neural network 1928 (or one of other machine learning models, as described herein) capable of performing, for example, classification and clustering operations. In other examples, the training phase 1902 may involve deep learning, in which the training data 1908 is unstructured, and the trained machine-learning program 1914 implements a deep neural network 1928 that is able to perform both feature extraction and classification/clustering operations.

A neural network 1928 generated during the training phase 1902, and implemented within the trained machine-learning program 1914, may include a hierarchical (e.g., layered) organization of neurons. For example, neurons (or nodes) may be arranged hierarchically into a number of layers, including an input layer, an output layer, and multiple hidden layers. The layers within the neural network 1928 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1928 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 1904 the trained machine-learning program 1914 is used to perform an assessment. Query data 1912 is provided as an input to the trained machine-learning program 1914, and the trained machine-learning program 1914 generates the assessment 1916 as output, responsive to receipt of the query data 1912.

### Example: Storing a Trained Model With ONNX File Format

A trained neural network model (e.g., a trained machine learning program 1914 using a neural network 1928) may be stored in a computational graph format, according to some examples. An example computational graph format is the Open Neural Network Exchange (ONNX) file format, an open, flexible standard for storing models which allows reusing models across deep learning platforms/tools, and deploying models in the cloud (e.g., via ONNX runtime).

In some examples, the ONNX file format corresponds to a computational graph in the form of a directed graph whose nodes (or layers) correspond to operators and whose edges correspond to tensors. In some examples, the operators (or operations) take the incoming tensors as inputs, and output result tensors, which are in turn used as inputs by their children.

In some examples, trained neural network models (e.g., examples of trained machine learning programs 1914) developed and trained using frameworks such as TensorFlow, Keras, PyTorch, and so on can be automatically exported to the ONNX format using framework-specific export functions. For instance, PyTorch allows the use of a torch.export(trainedModel, outputFile( . . . )) function to export a trained model ready to be run to a file using the ONNX file format. Similarly, TensorFlow and Keras allow the use of the tf2onnx library for converting trained models to the ONNX file format, while Keras also allows the use of keras2onnx for the same purpose.

In example embodiments, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

### Examples

Example 1 is a system comprising: one or more computer processors; one or more computer memories; and a set of instructions stored in the one or more computer memories, the set of instructions configuring the one or more computer processors to perform operations, the operations comprising: accessing an input computational graph corresponding to a trained machine-learning (ML) model; converting the input computational graph into an internal computational graph corresponding to the trained ML model; determining characteristics of the internal computational graph; based on the determined characteristics, optimizing the internal computational graph to generate an optimized computational graph by applying one or more of at least a graph element reordering operation, a graph element fusing operation, or a graph element creation operation; converting the optimized computational graph to executable instructions enabled to be executed on an endpoint associated with a backend and a platform; generating scheduling instructions associated with the executable instructions; and executing the executable instructions on the endpoint based on the scheduling instructions.

In Example 2, the subject matter of Example 1 includes, wherein graph elements of the internal computational graph comprise layers associated with layer inputs and layer outputs, and wherein: one or more of the layers correspond to supported operators; layer inputs comprise constant inputs or variable inputs; and layer inputs and layer outputs are associated with one or more layouts.

In Example 3, the subject matter of Example 2 includes, wherein the supported operators correspond to mathematical operations, the supported operators to comprise one or more of at least a convolution operation, an activation function operation, a pooling operation, a reduction operation, or a data transfer operation.

In Example 4, the subject matter of Examples 2-3 includes, wherein characteristics of the internal computational graph comprise global characteristics and local characteristics; the global characteristics further comprise an indicator of the internal computational graph being topologically sorted; the local characteristics further comprise one or more of at least: determining complete shapes or partial shapes of one or more layer inputs or one or more layer outputs of one or more of the layers; and determining backend requirements associated with one or more of the layers.

In Example 5, the subject matter of Examples 2-4 includes, wherein the graph element reordering operation corresponds to a layer re-ordering operation; the graph element fusing operation corresponds to a layer fusing operation, a subgraph fusing operation or a constant fusing operation; and the graph element generation operation corresponds to a layer generation operation.

In Example 6, the subject matter of Examples 2-5 includes, the operations further comprising accessing information associated with the endpoint, and wherein: layers of the internal computational graph are associated with tensor outputs; the accessed information comprises a tensor layout associated with the endpoint; and optimizing the internal computational graph further comprises: determining that a layer of the internal computational graph has a tensor output layout different from the tensor layout; and automatically converting the tensor output layout to the tensor layout.

In Example 7, the subject matter of Examples 1-6 includes, the operations further comprising: accessing information associated with the endpoint, the endpoint being associated with a graphics processing unit (GPU) backend, the information comprising a wave size associated with the GPU backend and indicating a predetermined number of synchronous threads; and converting the optimized computational graph, using at least the wave size, to optimized executable instructions enabled to be executed on the endpoint.

In Example 8, the subject matter of Examples 1-7 includes, wherein the executable instructions forgo any reference to elements of the input computational graph, internal computational graph or optimized computational graph.

In Example 9, the subject matter of Examples 1-8 includes, wherein converting the optimized computational graph to executable instructions enabled to be executed on the endpoint further comprises: converting the optimized computational graph to initial executable instructions; accessing information about the platform associated with the endpoint, the information comprising an Application Programming Interface (API) associated with the platform; and converting the initial executable instructions to the executable instructions based on the API associated with the platform.

In Example 10, the subject matter of Examples 2-9 includes, wherein each supported operator of the supported operators is associated with a kernel corresponding to a set of executable instructions associated with the backend, the set of executable instructions implementing the supported operator on the backend.

In Example 11, the subject matter of Examples 6-10 includes, wherein converting the optimized computational graph to initial executable instructions further comprises: determining layers of the optimized computational graph meeting one of a plurality of predefined criteria, the layers corresponding to one or more supported operators; and fusing kernels associated with the one or more supported operators associated with the determined layers of the optimized computational graph.

In Example 12, the subject matter of Examples 1-11 includes, receiving user input comprising a specification of one of at least a layer creation operation, a layer modification operation, an execution graph associated with a layer, or a selection of a backend associated with a layer; and upon receiving the user input, modifying the internal computational graph based on the user input.

In Example 13, the subject matter of Examples 1-12 includes, wherein the endpoint is associated with an additional backend, the operations further comprising: based on the determined characteristics of the internal computational graph: determining a first subgraph of the optimized computational graph, the first subgraph to be converted to a first set of optimized executable instructions associated with the backend; and determining a second subgraph of the optimized computational graph, the second subgraph to be converted to a second set of optimized executable instructions associated with the additional backend.

Example 14 is at least one non-transitory computer-readable medium (or machine-readable medium) including instructions that, when executed by processing circuitry, cause the processing circuitry to perform operations to implement any of Examples 1-13.

Example 15 is an apparatus comprising means to implement any of Examples 1-13.

Example 16 is a system to implement any of Examples 1-13.

Example 17 is a method to implement any of Examples 1-13.

In some examples, a model execution system 200 (e.g., as a runtime with inference operating in real-time and on a device) can be configured to connect via API to another third-party AI service (e.g., like ChatGPT or similar). The connection would allow the model execution system 200 and the third-party AI service to exchange data via inputs and outputs such that the output (or part thereof) from one may be used as input to the other, and vice versa.

In some examples, a model execution system 200 (e.g., as a runtime with inference operating in real-time and on a device) can be configured to connect to a user acquisition service (e.g., such as Unity Audience Pinpointer) that uses machine learning to help you discover players most likely to have value beyond an initial app install (e.g., users who are most likely to continue playing a game). For example, the model execution system 200 can communicate with the user acquisition service to determine dynamic pricing (e.g., a price paid for impressions or installs depending on a predicted value of a user in a game), and allow the model execution system 200 to bid more (e.g., a higher dollar amount) for predicted high-value users, and bid less for users who are likely to not continue playing a game after installation.

In some examples, a model execution system 200 (e.g., as a runtime with inference operating in real-time and on a device) can be configured to enable a game creator to allow non-player characters (NPCs) to leverage natural language (e.g., via large language models LLMs) to spontaneously and appropriately dialogue with another NPC and/or with a player.

In some examples, a model execution system 200 (e.g., as a runtime with inference operating in real-time and on a device) can be configured to drive NPC actions in a game based on situation (e.g., gameplay) and goals within the game environment (e.g., using game environment and state data).

In some examples, a model execution system 200 (e.g., as a runtime with inference operating in real-time and on a device) can be configured to allow a player of a game to tune (e.g., change, iteratively modify) NPC behaviors including dialogue and movement in real-time while playing the game. The tuning can be based on input from a user (e.g., a suggested theme (e.g., cultural, religious, etc.)) and/or contextual data from within a game (e.g., game state, environment, player progression within the game, and more), and/or gameplay (e.g., a recent history of gameplay decisions and actions by a player).

In some examples, a model execution system 200 (e.g., as a runtime with inference operating in real-time and on a device) can be configured to deduce (e.g., determine) a likelihood, based on on-device computation and device inputs, whether a user is in a good mood, a bad mood, ready to purchase an in-game item or not, cycle out of a game or not, and more. The device inputs can include data from one or more cameras filming the user, text data received by a keyboard or touchscreen, voice data received by a microphone, and other biometric data received by the device. In accordance with an embodiment, the deductions (e.g., determinations) listed above may not violate prevailing privacy regulations based on the device inputs and model execution system 200 being on-device (e.g., not sending the data off-device).

In some examples, a model execution system 200 (e.g., as a runtime with inference operating in real-time and on a device) can be configured such that, when used in conjunction with a Digital Twin (e.g., including using IoT real-time data), can go beyond running simulations specifically requested by a user for various scenarios, but rather anticipate possible future needs for anticipated possible future scenarios and act proactively to propose solutions. As an example: In an Airport, the model execution system 200 may recognize that congestion is likely to occur based on IoT data received from devices within the airport, and suggest mitigating solutions before any congestion occurs.

In some examples, a model execution system 200 (e.g., as a runtime with inference operating in real-time and on a device) can be configured to provide texture generation. The texture generation can include changing one or more game object textures (e.g., including entire game level texture themes) in real-time based on input from a user (e.g., a suggested theme) and/or contextual data from within a game (e.g., game state, environment, player progression within the game, and more), and/or gameplay (e.g., a recent history of gameplay decisions and actions by a player). For example, a user may ask for (e.g., using voice input via a microphone on the device) a change in game textures to change a look/style of enemy characters based on a suggested theme.

In some examples, a model execution system 200 (e.g., as a runtime with inference operating in real-time and on a device) can be configured to provide real-time assisted audio, including modifying part or all of a game soundtrack (e.g., including music), and modifying game sounds based on input from a user (e.g., a suggested theme, or musical artist) and/or contextual data from within a game (e.g., game state, environment, player progression within the game, and more), and/or gameplay (e.g., a recent history of gameplay decisions and actions by a player). For example, a user may ask for (e.g., using voice input via a microphone on the device) a change in game soundtrack to change the mood to be more upbeat.

In some examples, a model execution system 200 (e.g., as a runtime with inference operating in real-time and on a device) can be configured to generate 3D assets. The 3D assets can be generated in real-time during gameplay based on input from a user (e.g., a suggested object and/or theme) and/or contextual data from within a game (e.g., game state, environment, player progression within the game, and more), and/or gameplay (e.g., a recent history of gameplay decisions and actions by a player). For example, a user may ask for (e.g., using voice input via a microphone on the device) more enemy characters during a game.

In accordance with example embodiments, a model execution system 200 (e.g., as a runtime with inference operating in real-time and on a device) may be configured to generate 2D assets. The 2D assets may be generated in real-time during gameplay based on input from a user (e.g., a suggested object and/or theme) and/or contextual data from within a game (e.g., game state, environment, player progression within the game, and more), and/or gameplay (e.g., a recent history of gameplay decisions and actions by a player).

In some examples, a model execution system 200 (e.g., as a runtime with inference operating in real-time and on a device) can be configured to generate dynamic gameplay evolution. Accordingly, the model execution system 200 can adapt gameplay mechanics in real-time during gameplay based on input from a user (e.g., a suggested theme) and/or contextual data from within a game (e.g., game state, environment, player progression within the game, and more), and/or gameplay (e.g., a recent history of gameplay decisions and actions by a player). This adapted gameplay can include modifying game level structure, difficulty settings, achievements, and more.

In some examples, a model execution system 200 (e.g., as a runtime with inference operating in real-time and on a device) can be configured to create or learn new behaviors for characters and entities.

In some examples, a model execution system 200 (e.g., as a runtime with inference operating in real-time and on a device) can be configured to provide assisted character animation.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“SHADER” in this context refers to program that runs on a GPU, CPU, TPU, NPU, and so forth. Shader programs may be part of a graphics pipeline. Shaders may also be compute shaders or programs that perform calculations on a CPU or a GPU (e.g., outside of a graphics pipeline, etc.). Shaders may perform calculations that determine pixel properties (e.g., pixel colors). Shaders may refer to ray tracing shaders that perform calculations related to ray tracing. A shader object (e.g., an instance of a shader class) may be a wrapper for shader programs and other information. A shader asset may refer to a shader file (or a “shader” extension file), which may define a shader object.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more computer processors;
one or more computer memories; and
a set of instructions stored in the one or more computer memories, the set of instructions configuring the one or more computer processors to perform operations, the operations comprising:
accessing an input computational graph corresponding to a trained machine-learning (ML) model;
converting the input computational graph into an internal computational graph corresponding to the trained ML model;
determining characteristics of the internal computational graph;
based on the determined characteristics, optimizing the internal computational graph to generate an optimized computational graph by applying one or more of at least a graph element reordering operation, a graph element fusing operation, or a graph element creation operation;
converting the optimized computational graph to executable instructions enabled to be executed on an endpoint associated with a backend and a platform;
generating scheduling instructions associated with the executable instructions; and
executing the executable instructions on the endpoint based on the scheduling instructions.

2. The system of claim 1, wherein graph elements of the internal computational graph comprise layers associated with layer inputs and layer outputs, and wherein:
one or more of the layers correspond to supported operators;
layer inputs comprise constant inputs or variable inputs; and
layer inputs and layer outputs are associated with one or more layouts.

3. The system of claim 2, wherein the supported operators correspond to mathematical operations, the supported operators to comprise one or more of at least a convolution operation, an activation function operation, a pooling operation, a reduction operation, or a data transfer operation.

4. The system of claim 2, wherein characteristics of the internal computational graph comprise global characteristics and local characteristics;
the global characteristics further comprise an indicator of the internal computational graph being topologically sorted;
the local characteristics further comprise one or more of at least:
determining complete shapes or partial shapes of one or more layer inputs or one or more layer outputs of one or more of the layers; and
determining backend requirements associated with one or more of the layers.

5. The system of claim 2, wherein the graph element reordering operation corresponds to a layer re-ordering operation;
the graph element fusing operation corresponds to a layer fusing operation, a subgraph fusing operation or a constant fusing operation; and
the graph element generation operation corresponds to a layer generation operation.

6. The system of claim 2, the operations further comprising accessing information associated with the endpoint, and wherein:
layers of the internal computational graph are associated with tensor outputs;
the accessed information comprises a tensor layout associated with the endpoint; and
optimizing the internal computational graph further comprises:
determining that a layer of the internal computational graph has a tensor output layout different from the tensor layout; and
automatically converting the tensor output layout to the tensor layout.

7. The system of claim 1, the operations further comprising:
accessing information associated with the endpoint, the endpoint being associated with a graphics processing unit (GPU) backend, the information comprising a wave size associated with the GPU backend and indicating a predetermined number of synchronous threads; and
converting the optimized computational graph, using at least the wave size, to optimized executable instructions enabled to be executed on the endpoint.

8. The system of claim 1, wherein the executable instructions forgo any reference to elements of the input computational graph, internal computational graph or optimized computational graph.

9. The system of claim 1, wherein converting the optimized computational graph to executable instructions enabled to be executed on the endpoint further comprises:
converting the optimized computational graph to initial executable instructions;
accessing information about the platform associated with the endpoint, the information comprising an Application Programming Interface (API) associated with the platform; and
converting the initial executable instructions to the executable instructions based on the API associated with the platform.

10. The system of claim 2, wherein each supported operator of the supported operators is associated with a kernel corresponding to a set of executable instructions associated with the backend, the set of executable instructions implementing the supported operator on the backend.

11. The system of claim 6, wherein converting the optimized computational graph to initial executable instructions further comprises:
determining layers of the optimized computational graph meeting one of a plurality of predefined criteria, the layers corresponding to one or more supported operators; and
fusing kernels associated with the one or more supported operators associated with the determined layers of the optimized computational graph.

12. The system of claim 1, further comprising:
receiving user input comprising a specification of one of at least a layer creation operation, a layer modification operation, an execution graph associated with a layer, or a selection of a backend associated with a layer; and
upon receiving the user input, modifying the internal computational graph based on the user input.

13. The system of claim 1, wherein the endpoint is associated with an additional backend, the operations further comprising:
based on the determined characteristics of the internal computational graph:
determining a first subgraph of the optimized computational graph, the first subgraph to be converted to a first set of optimized executable instructions associated with the backend; and
determining a second subgraph of the optimized computational graph, the second subgraph to be converted to a second set of optimized executable instructions associated with the additional backend.

14. A computer-implemented method, comprising:
accessing an input computational graph corresponding to a trained machine-learning (ML) model;
converting the input computational graph into an internal computational graph corresponding to the trained ML model;
determining characteristics of the internal computational graph;
based on the determined characteristics, optimizing the internal computational graph to generate an optimized computational graph by applying one or more of at least a graph element reordering operation, a graph element fusing operation, or a graph element creation operation;
converting the optimized computational graph to executable instructions enabled to be executed on an endpoint associated with a backend and a platform;
generating scheduling instructions associated with the executable instructions; and
executing the executable instructions on the endpoint based on the scheduling instructions.

15. The computer-implemented method of claim 14, wherein graph elements of the internal computational graph comprise layers associated with layer inputs and layer outputs, and wherein:
one or more of the layers correspond to supported operators;
layer inputs comprise constant inputs or variable inputs; and
layer inputs and layer outputs are associated with one or more layouts.

16. The computer-implemented method of claim 15, further comprising accessing information associated with the endpoint, and wherein:
layers of the internal computational graph are associated with tensor outputs;
the accessed information comprises a tensor layout associated with the endpoint; and
optimizing the internal computational graph further comprises:
determining that a layer of the internal computational graph has a tensor output layout different from the tensor layout; and
automatically converting the tensor output layout to the tensor layout.

17. The computer-implemented method of claim 14, further comprising:
accessing information associated with the endpoint, the endpoint being associated with a graphics processing unit (GPU) backend, the information comprising a wave size associated with the GPU backend and indicating a predetermined number of synchronous threads; and
converting the optimized computational graph, using at least the wave size, to optimized executable instructions enabled to be executed on the endpoint.

18. The computer-implemented method of claim 14, wherein the endpoint is associated with an additional backend, the method further comprising:
based on the determined characteristics of the internal computational graph:
determining a first subgraph of the optimized computational graph, the first subgraph to be converted to a first set of optimized executable instructions associated with the backend; and
determining a second subgraph of the optimized computational graph, the second subgraph to be converted to a second set of optimized executable instructions associated with the additional backend.

19. The computer-implemented method of claim 14, wherein converting the optimized computational graph to executable instructions enabled to be executed on the endpoint further comprises:
converting the optimized computational graph to initial executable instructions;
accessing information about the platform associated with the endpoint, the information comprising an Application Programming Interface (API) associated with the platform; and
converting the initial executable instructions to the executable instructions based on the API associated with the platform.

20. A non-transitory computer-readable storage medium storing instructions that, when executed by at least one processor, cause the at least one processor to perform operations comprising:
accessing an input computational graph corresponding to a trained machine-learning (ML) model;
converting the input computational graph into an internal computational graph corresponding to the trained ML model;
determining characteristics of the internal computational graph;
based on the determined characteristics, optimizing the internal computational graph to generate an optimized computational graph by applying one or more of at least a graph element reordering operation, a graph element fusing operation, or a graph element creation operation;
converting the optimized computational graph to executable instructions enabled to be executed on an endpoint associated with a backend and a platform;
generating scheduling instructions associated with the executable instructions; and
executing the executable instructions on the endpoint based on the scheduling instructions.
